(19) United States
(12) Patent Application Publication
(10) Pub. No.: US 2024/0242080 A1
(43) Pub. Date: Jul. 18, 2024

(54) METHODS AND SYSTEMS FOR ROBUST TRAINING OF NEURAL NETWORKS

(71) Applicant: SAFE INTELLIGENCE AI, London (GB)

(72) Inventors: Patrick Henriksen, London (GB); Alessio Lomuscio, London (GB)

(21) Appl. No.: 18/416,851

(22) Filed: Jan. 18, 2024

Related U.S. Application Data
(60) Provisional application No. 63/480,345, filed on Jan. 18, 2023.

(51) Int. Cl. G06N 3/084

(52) U.S. Cl. CPC G06N 3/084

(57) ABSTRACT

The present disclosure relates to systems, methods, and computerized techniques for robust training of neural networks (NNs) against various perturbations of their inputs. More specifically, the disclosed techniques introduce abstraction-based robust training methods with one or more features as identified herein. One such NN training feature can include a Reversed Symbolic Interval Propagation-Standard Symbolic Interval Propagation (RSIP-SSIP) abstraction method. RSIP-SSIP can use a combination of SSIP and RSIP to calculate an abstraction of the NN for a given type of perturbation of the NN's inputs. The RSIP-SSIP method can further be used to calculate bounds on reachable values of nodes in the underlying NN, which, in turn, may be used to define loss functions that promote robustness to the given type of perturbation, or any other type of perturbation, including bias field perturbations.

### CROSS-REFERENCE TO RELATED APPLICATIONS

The present application claims priority to and the benefit of U.S. Provisional Application No. 63/480,345, entitled “A Method for Robust Training of Neural Networks” and filed on Jan. 18, 2023, the content of which is incorporated herein by reference in its entirety.

### FIELD

The present disclosure relates to systems, methods, and computer techniques for robust training of neural networks (NNs, or NN in singular form), and, more specifically, to improve robustness to perturbations of inputs.

### BACKGROUND

The general purpose of the disclosed technology is to address training needs for NNs. NNs have achieved significant performance for a wide range of tasks over the past few decades. They may be considered an essential component in automating challenging tasks such as natural language processing and computer vision. However, NNs often may be fragile to perturbations of the networks' inputs.

This fragility of NNs may be unacceptable in some applications, especially safety-critical applications, such as in autonomous vehicles and medical applications. Thus, methods for creating NNs that are robust to perturbations of their inputs are of high importance in practical applications.

Some methods for robust training of NNs is based on augmenting a training set with adversarial examples and various robustness-promoting loss functions. While these methods may produce networks with good empirical robustness, they can be limited in that they: (i) may not consider all adversarial examples for the perturbation under consideration; (ii) may not produce formal guarantees for robustness of the network; and (iii) mostly may target white noise perturbations of the inputs.

Some abstraction-based methods may be used for robust training. These methods can use abstractions to calculate overestimating reachable sets for the networks' output which, in turn, can be used in loss functions to promote robustness. The abstractions may encapsulate various adversarial examples in a perturbation region and produce lower bounds on the network's robustness. However, most abstraction-based methods may be limited to white noise perturbations.

Perturbations other than white noise, such as contrast, brightness, and other smooth intensity perturbations remain of high interest in practice. Accordingly, there is a need for improved methods of training NNs to promote robustness to various types of perturbations of NN inputs.

### SUMMARY

This Summary introduces a selection of concepts in simplified form that are described further below in the Detailed Description. This Summary neither identifies key or essential features, nor limits the scope, of the claimed subject matter.

The present disclosure relates to systems, methods, and computerized techniques for robust training of NNs against a range of perturbations of their inputs. The disclosed technology can address perturbations other than just white noise using techniques that mathematically reduce the perturbation(s) under consideration to a white noise perturbation. The disclosed technology can provide for training neural networks such that they are robust against various smooth intensity perturbations that can be modelled by bias fields. More specifically, the disclosed technology introduces an abstraction-based robust training method with one or more features as identified herein. One such feature is a Reversed Symbolic Interval Propagation-Standard Symbolic Interval Propagation (RSIP-SSIP) abstraction method that can be implemented for NN training. RSIP-SSIP can use a combination of two symbolic interval propagation-based variants—Standard Symbolic Interval Propagation (SSIP) and Reversed Symbolic Interval Propagation (RSIP)—to calculate an abstraction of the network for a given white noise perturbation. The RSIP-SSIP abstraction can be used to calculate bounds on reachable values of nodes in the underlying NN, which, in turn, may be used to define loss functions that promote robustness to white noise perturbations of the inputs. The RSIP-SSIP abstraction method can address limitations with other training methods, such Interval Bound Propagation (IBP) and/or RSIP-IBP, when applied to bias field robust training.

Moreover, the disclosed technology provides for mathematically reducing a problem of training networks that are robust to transformations of inputs to a standard problem of robust training. The reduction can be performed by encoding a transformation as one or more neural network operations, which can be prepended to the original NN. The set of operations can hereafter be referred to as transformation layers. The NN with the prepended transformation layers can be referred to as a transform network. The transform network can, for instance, be used in combination with RSIP-SSIP to derive loss functions that promote robustness to brightness, contrast, and/or bias field perturbations of the input, rather than just white noise perturbations.

Accordingly, the disclosed technology can further provide for combining RSIP-SSIP, which supports white noise robust training, with transform layers that reduce other perturbation types to white noise perturbations. These techniques are described herein with illustrative examples of bias field robust training, i.e., robust training of NNs against bias field perturbations of the input.

Bias field perturbations can model a wide range of smooth, spatially varying intensity changes via multiplicative and additive polynomials. For instance, brightness and contrast perturbations can be instantiations of 0-order bias field perturbations. While bias field perturbations can be used to model noise in MRI images from imperfections in magnetic imaging equipment and electrodynamic interactions, such perturbations can also be used to model smooth intensity changes in natural images due, at least in part, to changes in lighting conditions. This can make them a useful perturbation to explore in the context of robust training of NNs. As described herein, the disclosed technology can further provide an encoding such that white noise robust training methods can become applicable to bias field perturbations.

One embodiment described herein includes a method for white noise robust training of a neural network (NN). The method includes receiving, by a computer system, an NN, a loss function for the NN, and a dataset of perturbations. The method also includes, iteratively, by the computer system, two calculating actions and an optimizing action. One calculating action involves calculating, using standard symbolic interval propagation (SSIP), bounds for at least a portion of intermediate nodes in the NN, with the calculating action using SSIP being based on the dataset of perturbations. The second calculating action involves calculating, using reversed symbolic interval propagation (RSIP), at least one of an upper bound or a lower bound on a robust loss function, with the calculating action using RSIP being based on each of: (i) the calculated bounds for the at least a portion of intermediate nodes; (ii) the dataset of perturbations; and (iii) the loss function for the NN. The optimizing action involves optimizing, based on the calculated bounds and the at least one of an upper bound or lower bound, parameters of the NN. Still further, the method includes returning, by the computer system, the optimized NN.

The disclosed embodiment can include one or more of the following features. For example, the neural network training techniques can include stochastic gradient descent. Optimizing the parameters of the NN can use NN training techniques. Optimizing the parameters of the NN can include applying regularization techniques to the optimized NN. Optimizing the parameters of the NN can include applying artificial data augmentation to the optimized NN. The artificial data augmentation may include at least one of flips, rotations, one or more loss functions, or optimization methods. The loss function for the NN can include a user-defined loss function value. The dataset of perturbations can include at least one of bias field input changes, white noise input changes, brightness input changes, or contrast input changes. The dataset of perturbations may include at least one perturbation that can be encoded into (i) one or more layers of the NN or (ii) a composition of multiple layers of the NN. The parameters of the NN can include at least one of weights or biases of layers of the NN. Sometimes, the method may also include: receiving, by the computer system, a normal dataset, and generating, by the computer system, the dataset of perturbations based on applying one or more rules to each data point in the normal dataset, the one or more rules specifying perturbations and/or neighborhoods of each data point.

An embodiment described herein includes a system for white noise robust training of a neural network (NN). The system includes a computer system that is configured to perform a process that includes receiving an NN, a loss function for the NN, and a dataset of perturbations. The process that the computer system is configured to perform also includes iteratively performing two calculating actions and an optimizing action. One calculating action involves calculating, using standard symbolic interval propagation (SSIP), bounds for at least a portion of intermediate nodes in the NN, with the calculating action using SSIP being based on the dataset of perturbations. The second calculating action involves calculating, using reversed symbolic interval propagation (RSIP), at least one of an upper bound or a lower bound on a robust loss function, with the calculating action using RSIP being based on each of: (i) the calculated bounds for the at least a portion of intermediate nodes; (ii) the dataset of perturbations; and (iii) the loss function for the NN. The optimizing action involves optimizing, based on the calculated bounds and the at least one of an upper bound or lower bound, parameters of the NN. Still further, the process that the computer system is configured to perform includes returning the optimized NN.

The system can optionally include one or more of the features described above in reference to the example embodiment of the method for white noise robust training of an NN.

Another embodiment described herein includes a method for robust training of neural networks (NN) with a transform network. The method includes receiving, by a computer system, an NN, a loss function for the NN, and a training dataset. The method also includes, iteratively, by the computer system, and for at least one data point in the training dataset, a generating action, a calculating action, and an optimizing action. The generating action involves generating a transform network based on augmenting the NN. The calculating action involves calculating, using the loss function of the NN, at least an upper bound on a robust loss function for the NN, with the calculating action being based on applying a relaxation technique to the transform network. The optimizing action involves optimizing, based on the calculated upper bound, parameters of the NN. Still further, the method includes returning, by the computer system, the optimized NN.

The disclosed embodiment can include one or more of the following features. For example, the iteratively generating, calculating, and optimizing operations can be performed, by the computer system, until a predefined condition is satisfied. Generating the transform network based on augmenting the NN can include encoding one or more brightness transformations into at least one layer of the NN. Generating the transformation network based on augmenting the NN can include encoding one or more contrast transformations into at least one layer of the NN. Generating the transform network can include pre-pending one or more transform layers to the NN, the one or more transform layers encoding perturbations for which to robustify the NN against, the transform network being a composition of the NN and the one or more pre-pended transform layers. The relaxation technique can include at least one of RSIP, SSIP, SIP, abstract interpretation-based methods, software-defined perimeter (SDP) based methods, partial linearization of a Rectified Linear Units (ReLU) activation function, or total linearization of the ReLU activation function.

An embodiment described herein includes a system for robust training of neural networks (NN) with transformation layers. The system includes a computer system that is configured to perform a process that includes receiving, an NN, a loss function for the NN, and a training dataset. The process that the computer system is configured to perform also includes iteratively, and for at least one data point in the training dataset, performing a generating action, a calculating action, and an optimizing action. The generating action involves generating a transform network based on augmenting the NN. The calculating action involves calculating, using the loss function of the NN, at least an upper bound on a robust loss function for the NN, with the calculating action being based on applying a relaxation technique to the transform network. The optimizing action involves optimizing, based on the calculated upper bound, parameters of the NN. Still further, the process that the computer system is configured to perform includes returning the optimized NN.

The disclosed system can optionally include one or more of the features described above in reference to the example embodiment of a method for robust training of NNs with transformation layers.

Still another embodiment described herein includes a method for training a neural network (NN) with transformation layers using reversed symbolic interval propagation (RSIP) techniques and standard symbolic interval propagation (SSIP) techniques (RSIP-SSIP techniques). The method includes receiving, by a computer system, an NN, a loss function for the NN, and a training dataset. The method also includes, iteratively, by the computer system, and for at least one data point in the training dataset, a generating action, two calculating actions, and an optimizing action. The generating action includes generating a transform network based on augmenting the NN. One calculating action involves calculating, using SSIP, bounds for at least a portion of intermediate nodes in the transform network, with the calculating action using SSIP being based on the transform network. The second calculating action involves calculating, using RSIP, at least one of an upper bound or a lower bound on a robust loss function, with the calculating action using RSIP being based on each of: (i) the calculated bounds for the at least a portion of intermediate nodes; (ii) the loss function for the NN; and (iii) the transform network. The optimizing action involves optimizing, based on the calculated bounds and the at least one of an upper bound or lower bound, parameters of the NN. Still further, the method includes returning, by the computer system, the optimized NN.

The disclosed method can optionally include one or more of the following features. For example, the iteratively generating, calculating, calculating, and optimizing operations can be performed, by the computer system, until a predefined condition is satisfied. The predefined condition can include a predetermined threshold of iterations or epochs. The predefined condition can include a determination that the loss function of the NN is less than a predetermined threshold value. The predefined condition can include a determination that the loss function of the NN converged, the loss function of the NN converging when the loss function remains constant from iteration to iteration. Sometimes, calculating, using RSIP, at least one of an upper bound or a lower bound on a robust loss function may include back-propagating gradients through the at least one of an upper bound or a lower bound. As another example, calculating, using RSIP, at least one of an upper bound or a lower bound on a robust loss function further may include back-propagating gradients through the calculated bounds for the at least a portion of intermediate nodes. In some implementations, the method may also include calculating a standard training loss function based on output of a forward pass of the NN, calculating a total training loss function based on a weighted summation of the standard training loss function and the robust loss function, and optimizing the parameters of the NN based on back-propagation using the total training loss function. Augmenting the NN can include pre-pending one or more transform layers to the NN, each of the one or more transform layers can be based on the training dataset and at least one perturbation type.

An embodiment described herein includes a system for training a neural network (NN) with transformation layers using reversed symbolic interval propagation (RSIP) techniques and standard symbolic interval propagation (SSIP) techniques (RSIP-SSIP techniques). The system includes a computer system that is configured to perform a process that includes receiving an NN, a loss function for the NN, and a training dataset. The process that the computer system is configured to perform also includes iteratively, and for at least one data point in the training dataset, performing a generating action, two calculating actions, and an optimizing action. The generation action involves generating a transform network based on augmenting the NN. One calculating action involves calculating, using SSIP, bounds for at least a portion of intermediate nodes in the transform network, with the calculating action using SSIP being based on the transform network. The second calculating action involves calculating, using RSIP, at least one of an upper bound or a lower bound on a robust loss function, with the calculating action using RSIP being based on each of: (i) the calculated bounds for the at least a portion of intermediate nodes; (ii) the loss function for the NN; and (iii) the transform network. The optimizing action involves optimizing, based on the calculated bounds and the at least one of an upper bound or lower bound, parameters of the NN. Still further, the process that the computer system is configured to perform includes returning the optimized NN.

The disclosed system can optionally include one or more of the features described above in reference to the method for training an NN with transformation layers using RSIP-SSIP techniques.

The disclosed technology can provide one or more of the following advantages. The disclosed technology improves robustness of NNs for various types of perturbations, thereby increasing resilience and accuracy of such models and/or networks during runtime use and application. The disclosed technology can also provide for efficient training of low dimensional NNs, thereby making those NNs robust against perturbations that include at least one or more of white noise, brightness, contrast, and/or bias field. The disclosed technology can also provide more precise bounds in training, thereby resulting in more robust networks for runtime use. Furthermore, the disclosed technology can provide for improved compute time and/or memory usage in comparison to other methods and techniques.

### BRIEF DESCRIPTION OF THE DRAWINGS

The following Detailed Description references the accompanying drawings, which form a part this application, and which show, by way of illustration, specific, but not necessarily limiting, example implementations, in which:

FIG. 1 illustrates an example method for robust training of an NN;

FIG. 2 illustrates an example method for robust training of an NN using RSIP-SSIP training techniques;

FIG. 3 is a conceptual diagram of a system for white noise training of an NN using RSIP-SSIP training techniques;

FIG. 4 is a flowchart of a process for white noise training of an NN using RSIP-SSIP training techniques;

FIG. 5 illustrates an example method for robust training of an NN with transformation layers;

FIG. 6 is a conceptual diagram of a system for training an NN with transformation layers;

FIG. 7 is a flowchart of a process for training an NN with transformation layers;

FIG. 8 illustrates an example method for robust training of an NN with transformation layers and using RSIP-SSIP training techniques;

FIG. 9 is a conceptual diagram of a system for training an NN with transformation layers using RSIP-SSIP training techniques;

FIG. 10 is a flowchart of a process for training an NN with transformation layers using RSIP-SSIP training techniques;

FIG. 11A is a flowchart of a process for training an NN with out-of-distribution (OOD) data using RSIP-SSIP training techniques;

FIG. 11B illustrates tables showing results from training the NN with OOD data using RSIP-SSIP training techniques as described in the process shown in FIG. 11A;

FIG. 12 illustrates tables showing results from training NNs using RSIP-SSIP training techniques described herein; and

FIG. 13 is a schematic diagram that shows an example of a computing device and a mobile computing device.

### DETAILED DESCRIPTION

Certain exemplary embodiments will now be described to provide an overall understanding of the principles disclosed herein. One or more examples of these embodiments are illustrated in the accompanying drawings. Those skilled in the art will understand that the systems and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

Prior to describing inventive aspects of the present disclosure, it can be helpful to set out certain definitions and understandings as it relates to variables and the like used in conjunction with describing the features of the disclosed systems and methods. To that end, described herein, when defining neural network robustness, N:Rⁿ→R^{m} is intended to denote a neural network (NN) and x∈Rⁿ is intended to denote input to the NN. For notational convenience, NNs with 1-dimensional inputs may be considered only when an extension to more dimensions may be straightforward. In practice, an input set for an NN can be a single image and various other images can be created from that image by applying small amounts or types of noise to the image. Although a human eye may find all the images to look the same, differences in the images from applying the noise can become apparent to the NN. As described herein, the disclosed techniques can be applied to NNs that receive images as inputs. The disclosed techniques may also be applied to NNs that receive other types of inputs. For example, the disclosed techniques can be applied to NNs that receive any type of numeric inputs. Illustrative examples of numeric inputs include, but are not limited to, one-dimensional (1D) time series data (e.g., stock prices over time) and three-dimensional (3D) data (e.g., MRI scans). Sometimes NNs may implement embedding layers to convert non-numerical inputs to numeric inputs, such as large language models (LLMs). In such scenarios, perturbations, using the disclosed techniques, can be defined post-embedding layers.

Regarding NN robustness, a neural network N:Rⁿ→R^{m} can be robust with regards to inputs X⊂Rⁿ and output annotation y if N (x) is correct with respect to y for all x∈X. A common instantiation of robustness is white noise robustness where the input set is induced by box constraints. Accordingly, NN white noise robustness can be defined as follows: an NN N:Rⁿ→R^{m} is robust with regards to inputs X={x|x_{i,low}≤x≤x_{i,up}, x_{i,low}, x_{i,up}∈R} and output annotation y if N (x) is correct with respect to y for all x∈X. As an illustrative example, an input set can be created by allowing each element in an input vector to be perturbed between lower and upper bounds, which can model the white noise. Accordingly, every pixel of an image can change a little, independently of other pixels in the image.

Interval Bound Propagation (IBP) is a method for calculating over-approximating reachable output sets for NNs given input sets on the form X={xᵢ|x_{i,l}≤xᵢ≤x_{i,u}} for x_{i,l}, x_{i,u}∈R. The input bounds can be propagated through the NN on a layer-by-layer basis. For a fully connected layer i with lower and upper input bounds x_{i,l}ⁱ, x_{i,u}ⁱ, weight matrix Wⁱ, and bias bⁱ, the layer's output bounds can be computed as:

$${x}_{: , j}^{i + 1} = {W}_{+}^{i} {x}_{: , l}^{i} + {W}_{-}^{i} {x}_{: , u}^{i} + {b}^{i} and$$

$${x}_{: , u}^{i + 1} = {W}_{+}^{i} {x}_{: , u}^{i} + {W}_{-}^{i} {x}_{: , l}^{i} + {b}^{i} .$$

Here, W₊ⁱ and W₋ⁱ i are the weight matrices where negative and positive elements have been set to zero, respectively. Monotonously increasing activation functions σ:R→R (such as Rectified Linear Units (ReLU), defined by ReLU(x)=max(0, x), Sigmoid, defined by Sigmoid(x)=1/(1+e^{(-x)}), and Tan h, defined by Tan h(x)=(e^{x}−e^{(-x)})/(e^{x}+e^{(-x)})) can be handled by applying an activation function element-wise to the bounds. Sometimes, IBP can produce loose bounds for bias field perturbations, which can be detrimental to training.

Standard and Reversed Symbolic Interval Propagation (SSIP and RSIP) are, within the context of the present disclosure, extensions of IBP in which the bounds can be represented as linear equations of the network's input variables. In SSIP, the bounds can be initialized at the network's input layer and propagated to the output layer. In contrast, RSIP can initialize bounds at a layer of interest and back-substitutes the bounds' variables to the input layer. Both SIP versions may use linear relaxations of activation functions that can require calculating concrete bounds. In SSIP, these bounds can be calculated in a forward pass without significant additional computational costs. In RSIP, however, the bound propagation may have to be repeated for each activation layer.

Certain exemplary embodiments will now be described to provide an overall understanding of the principles disclosed herein. One or more examples of these embodiments are illustrated in the accompanying drawings. Those skilled in the art will understand that the systems and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

Unless otherwise defined, all technical terms used herein have the same meaning as commonly understood by one of ordinary skill in the art to which this disclosure belongs. Additionally, like-numbered components across embodiments generally have similar features unless otherwise stated or a person skilled in the art would appreciate differences based on the present disclosure and his/her knowledge. Accordingly, aspects and features of every embodiment may not be described with respect to each embodiment, but those aspects and features are applicable to the various embodiments unless statements or understandings are to the contrary.

### Robust Training

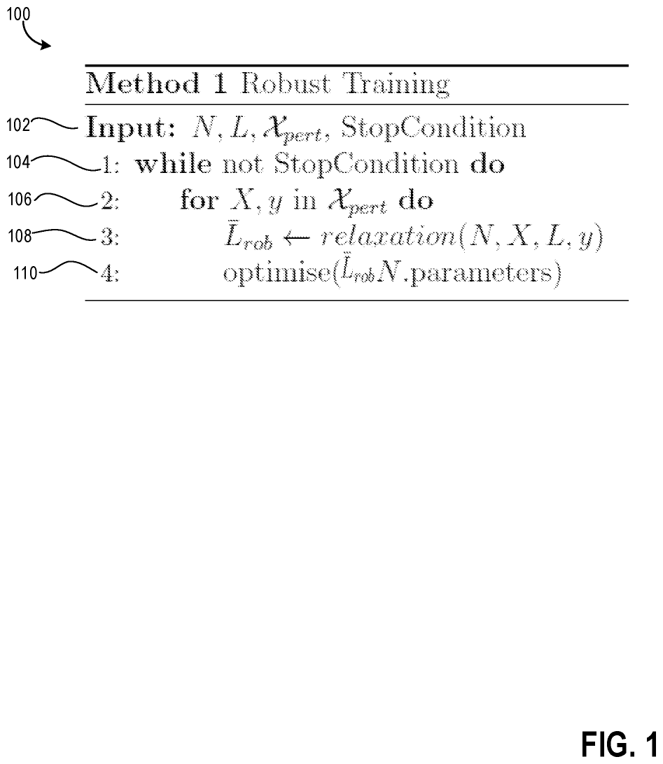

Now referring to the figures, FIG. 1 illustrates an example method 100 for generally performing robust training of an NN, using at least some definitions provided above. With regards to robust training of NNs, let N:Rⁿ→R^{m} be a neural network with parameters θ, L be a loss function, and Xₚₑᵣₜ be a set of two-tuples on the form (X, y) where X⊂R^{a} is a set of inputs and y is a training annotation. The robust training problem can be defined as follows:

$${min}_{θ} {E}_{( 𝒳 , y ) ∈ {𝒳}_{pert}} [ {max}_{x ∈ X} L ( N ( x ) ; y ) ] . \qquad ( 1 )$$

Due to inner maximization over X, the optimization problem can aim to minimize the expected loss for the “worst-case” x∈X. Consequentially, whenever the loss L encapsulates the desired network output behavior well, minimizing the expected loss can lead to robust networks as defined above in equation (1).

Analogously to the NN white noise robustness defined above, the robust training problem may be limited to white noise perturbations of the input.

Regarding white noise robust training, let N:Rⁿ→R^{m} be a neural network with parameters θ, L be a loss function, and Xₚₑᵣₜ be a set of two-tuples on the form (X, y) where X={x|x_{i,low}≤x≤x_{i,up}, x_{i,low}, x_{i,up}∈R} is a set of inputs and y is a training annotation. The white noise robust training problem can be defined as follows:

$${min}_{θ} {E}_{( 𝒳 , y ) ∈ {𝒳}_{pert}} [ {max}_{x ∈ X} L ( N ( x ) ; y ) ] . \qquad ( 2 )$$

Directly evaluating the inner maximization in the robust training problems may sometimes be challenging and/or infeasible. Thus, some robust training methods may use an upper-bounding relaxation instead. For instance, for white noise robust training problems where X is induced by box-constraints, i.e., X={x|x_{i,low}≤x≤x_{i,up}, x_{i,low}, x_{i,up}∈R}, symbolic interval propagation-based methods may be used to calculate upper bounds for the loss.

Accordingly, the method 100 presents a high-level method for robust training. Inputs 102 to the method 100 can include a neural network N, a loss function L, a dataset of perturbations X (defined by equation (1) shown above), and a stop condition (e.g., condition and/or criteria to be satisfied to perform the method 100). As shown by lines 1 and 2 (104, 106) of the method 100, a computer system as described herein can go through a while loop until the stop condition is met to train the network N for input sets x and annotation y in the dataset of perturbations. The method 100 can include of a nested loop, with a single pass of the inner loop being referred to as an iteration, and a full pass of the inner loop being referred to as an epoch. The inner loop first can use a relaxation technique (line 3, 108) to calculate bounds (e.g., upper bound(s), lower bound(s)) for all intermediate nodes (or a portion of the intermediate nodes of the network N). The method 100 may run for a pre-determined number of epochs and/or until any other predetermined stopping condition is reached. Then, the computer system can optimize parameters for the network N (line 4, 110).

### RSIP-SSIP for White Noise Robust Training

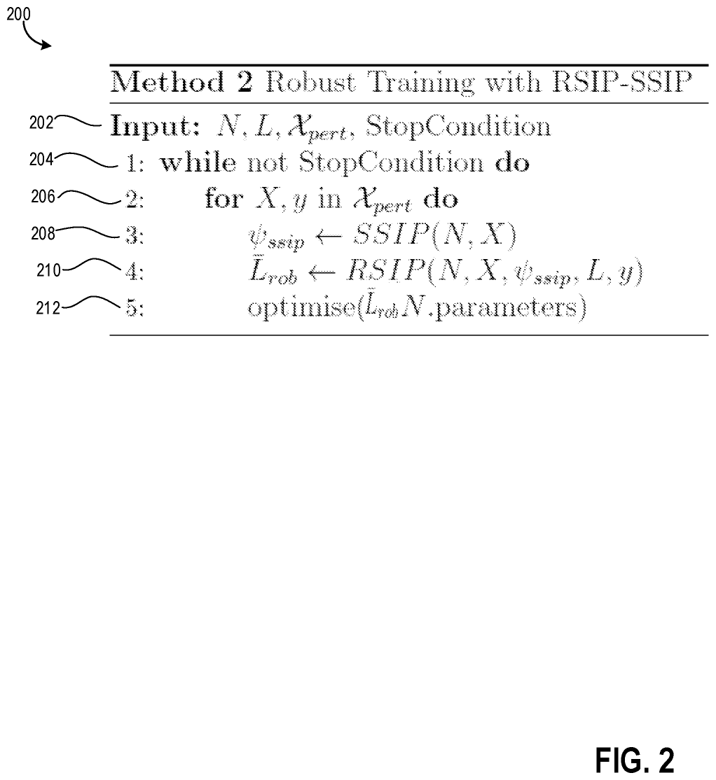

FIG. 2 illustrates an example method 200 for robust training of an NN using RSIP-SSIP training techniques. For example, the method 200 can be used for white noise robust training with the RSIP-SSIP techniques described herein. Using these techniques, reverse propagation can be performed multiple times. For example, a computer system described herein can calculate a reverse propagation for each layer in a network. The computer system may start with a first layer, then perform reverse propagation for a second layer using bounds that were determined for the first layer. The bounds can be calculated on a perturbed dataset. In at least some instances, the computer system may assume that the perturbations are white noise. As described herein, the perturbations can include, but are not limited to, contrast, brightness, and/or other changes to input data. For an output layer of the network, the computer system may use more complex reverse propagation techniques. These techniques can be beneficial because they are computationally efficient when working with many layers and low dimensional inputs for a network. These techniques may also be more precise than other training techniques that may be used, including but not limited to RSIP-IBP.

The method 200 takes as input 202 a network N, a loss function L, and dataset Xₚₑᵣₜ as defined above by equation (2) shown above. The method 200 comprises a nested loop, with a single pass of the inner loop being referred to as an iteration, and a complete pass of the inner loop being referred to as an epoch. The method 200 may run for a pre-determined number of epochs, or until a stopping condition is reached, as described above in reference to the method 700.

While the stop condition has not yet been met/satisfied (line 1, 204), the inner loop first can use SSIP techniques to calculate bounds for all intermediate nodes in the network (denoted ψₛₛᵢₚ) (lines 2 and 3, 206-208). The intermediate bounds from SSIP can then be used in RSIP to calculate an upper bound (denoted L⁻ rob) on the robust loss function (denoted L_{rob}, as defined above by the equation (2)) (line 4, 210). Finally, network parameters can be optimized using one or more standard neural network training methods (line 5, 212). Those training methods can include, but are not limited to, gradient descent, including stochastic variants such as ADAM (a replacement optimization algorithm for stochastic gradient descent), particle swarm optimization (where each particle has a virtual position that represents a possible solution to some minimization problem), and/or evolutionary optimization algorithms.

The robust training method presented in the method 200 may be combined with other training approaches for neural networks, which may include, but is/are not limited to, regularization techniques such as f₁- and f₂-loss, artificial data augmentation, such as flips and rotations, and various optimization methods, such as stochastic gradient descent-based methods and/or evolutionary methods, used to minimize various loss functions, such as mean-squared-error and/or cross-entropy loss.

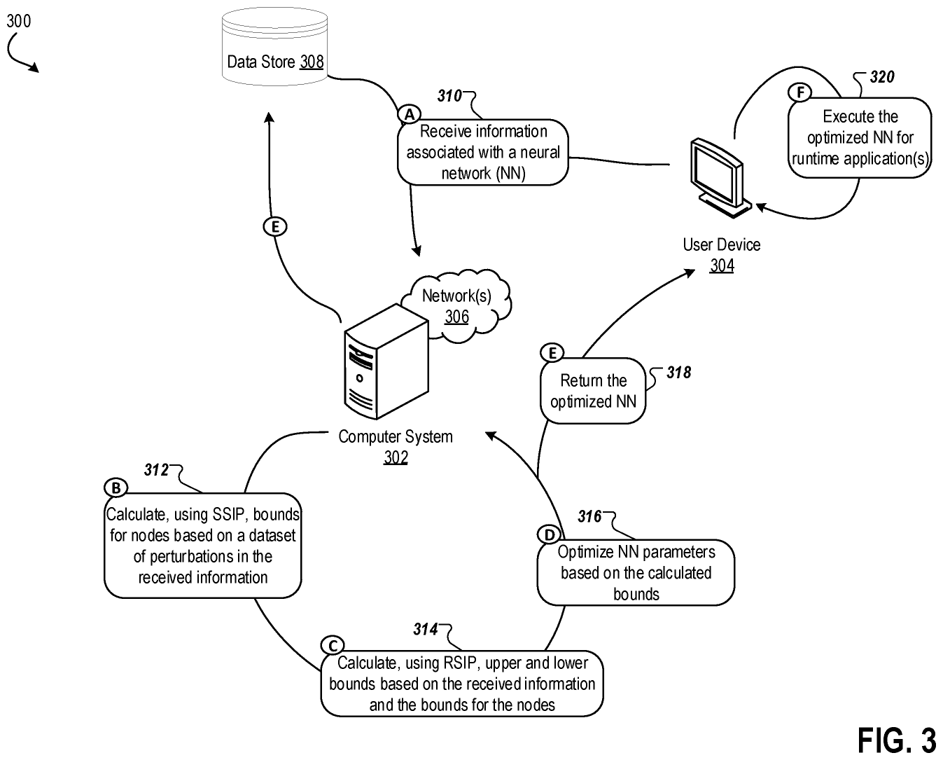

FIG. 3 is a conceptual diagram of a system 300 for white noise training of an NN using RSIP-SSIP training techniques. As shown in the example system 300, a computer system 302 can communicate with a user device 304 and/or data store 308 over one or more networks 306. In brief, the computer system 302 can be any type of computing system, network of computing devices, remote system, and/or cloud-based system. The computer system 302 can be configured to perform NN training methods described herein. The user device 304 can be a computing system, computing device, edge device, mobile device, or other type of device that can be used by a relevant user, such as a creator of an NN that may undergo the training methods described herein. The data store 308 can be any type of database, data repository, and/or cloud-based data storage system that can be configured to maintain information about NNs (e.g., NN datasets, training datasets, parameters, hyperparameters, etc.) and any of the training methods described herein or otherwise known to those skilled in the art. The network(s) 306 can be any type of wired and/or wireless communication between components of the system 300.

In the system 300, the computer system 302 can receive information associated with an NN (block A, 310). The information can include, but is not limited to, the NN, a loss function for the NN, and/or a dataset of perturbations. The information can be received from the data store 308 and/or the user device 304. The computer system 302 can receive an input dataset for the NN, then augment that dataset to generate the dataset of perturbations. The dataset of perturbations here can be specified by the normal input dataset and a set of rules that specify how to create a neighborhood around each data point in the normal input dataset to create the dataset of perturbations. Most SIP and verification approaches inherently support white noise rules, such as rules specified by constraints on a form of: x_{i, low}<=x_i′<=x_{i, up}. As an illustrative example of white noise, let X_norm be a set of tuples (x, y). X_pert can be a set of tuples (X, y) where each tuple (X, y) corresponds to a tuple (x, y) from the normal input dataset. The “y”'s can be the same in both tuples. The set X may be defined as all x′ such that x_{i, low}<=x_i′ <=x_{i, up} and x_{i, low}=x−ε and x_{i, up}=x+ε for some ε\in R. Thus, in a normal set of images, a dataset of perturbations can be a subset of the set of images if each pixel in each image of the normal set of images is set to vary a little, where that little variation can be specified by some real number denoted as ε.

The computer system 302 can calculate bounds for nodes of the NN, using, for example, SSIP techniques, with the calculation being based on the dataset of perturbations in the received information (block B, 312). Sometimes, the computer system 302 may determine bounds for at least a portion of intermediate nodes in the NN. The computer system 302 can determine the bounds for all the intermediate nodes in the NN. As an illustrative example, at least one input dataset X, which contain normal input x and also vectors in a neighborhood of x, can be passed through the NN. Passing a set “X” through the NN can represent all values that may result from passing any x′\in X through the NN. These sets of reachable values can be represented with the bounds calculated by propagation, such as symbolic interval propagation. Thus, a set of reachable values for the NN can be represented by lower and upper bounds, rather than representing only a single vector of concrete values with the normal input x.

Next, the computer system 302 can calculate upper and/or lower bounds, using, for example, RSIP techniques, with the calculation being based on the received information and/or the bounds for the nodes in the NN (block C, 314). The upper and/or lower bounds can be calculated on a robust loss function for the NN and/or can be determined based on the bounds for at least a portion of the intermediate nodes. Additionally, or alternatively, the upper and/or lower bounds can be determined based on the dataset of perturbations. Still further, additionally, or alternatively, the upper and/or lower bounds can be determined based on the loss function for the NN.

In block D (316), the computer system 302 can optimize one or more parameters of the NN based on the calculated bounds. The parameter(s) can be optimized, for example, based on the bounds for at least a portion of the intermediate nodes and/or the upper and/or lower bounds for the NN. The optimizable parameters in the NN can be referred to as weights and/or biases of one or more layers of the NN. Function of the weights and/or biases may differ between the layers and based on the layers. For example, in fully connected layers, the weights can be multiplicative matrices W and the biases can be additive vectors b. In convolutional layers, as another example, the weights can be convolutional kernels and the biases can be additive vectors of the same size as the number of output channels. In batch normalization, as yet another example, the weights can be multiplicative vectors (sometimes referred to as gamma) and the biases can be additive vectors (sometimes referred to as beta).

The optimized NN can be returned by the computer system 302 to the user device 304 and/or the data store 308 in block E (318). Sometimes, the user device 304 can execute the optimized NN for runtime application(s) (block F, 320).

In some implementations, blocks B-D (312-316) can be iteratively and/or continuously performed until a stop condition is satisfied. Sometimes, the blocks B-D (312-316) can be performed for every data point in the dataset of perturbations.

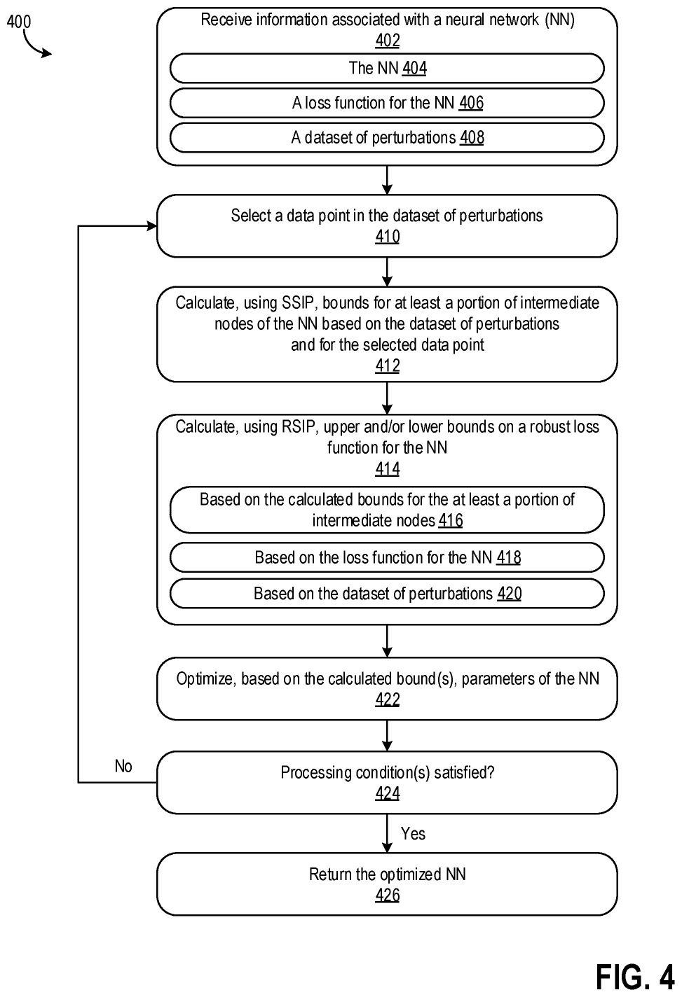

FIG. 4 is a flowchart of a process 400 for white noise training of an NN using RSIP-SSIP training techniques. The process 400 corresponds to operations described in reference to FIG. 3. The process 400 can be performed by the computer system 302. One or more blocks in the process 400 can also be performed by other computing systems, network of computing devices, and/or cloud-based computing systems. For illustrative purposes, the process 400 is described from the perspective of a computer system.

Referring to the process 400 in FIG. 4, the computer system can receive information associated with an NN in block 402. The information may include the NN (block 404), a loss function for the NN (block 406), and/or a dataset of perturbations (block 408).

The computer system can select a data point in the dataset of perturbations in block 410.

Then, the computer system can calculate, using, for example, SSIP techniques, bounds for at least a portion of intermediate nodes of the NN based on the dataset of perturbations and for the selected data point (block 412).

In block 414, the computer system can calculate, using, for example, RSIP techniques, bounds for upper and/or lower bounds on a robust function for the NN. This calculation can be based on the calculated bounds for the at least a portion of intermediate nodes (block 416), the loss function for the NN (block 418), and/or the dataset of perturbations (block 420).

The computer system may also optimize one or more parameters of the NN based on the calculated bound(s) in block 422.

In block 424, the computer system can determine whether one or more processing conditions is/are satisfied. If the processing condition(s) is not satisfied, the computer system returns to block 410 and repeats through one or more of the blocks 412-422 until the processing condition(s) is satisfied. If the processing condition(s) is satisfied, the computer system proceeds to block 426, in which the computer system returns the optimized NN.

Robust Training with Transformation Layers

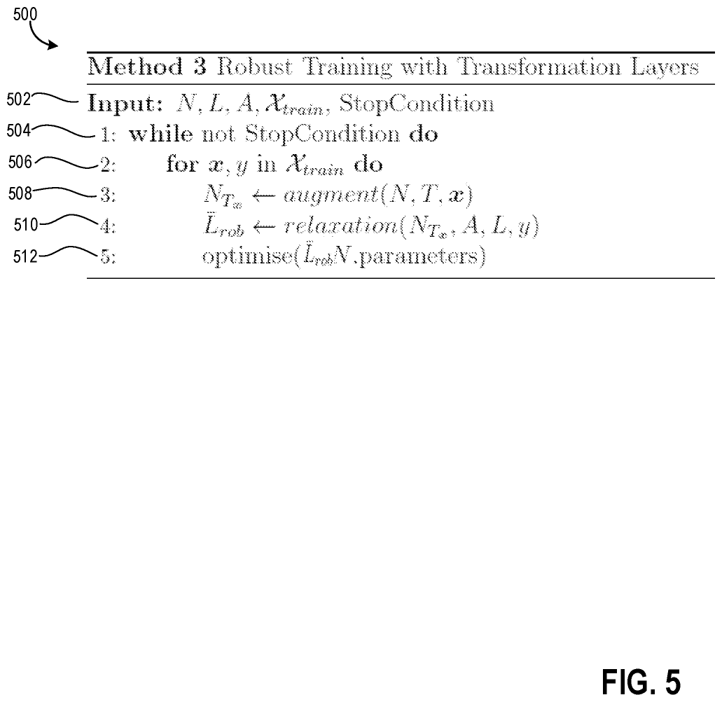

FIG. 5 illustrates an example method 500 for robust training of an NN with transformation layers. The method 500 can extend the method 100 to transformation layers. Robust training with transformation layers enables robust training of neural networks against input perturbations that may not inherently be supported by an underlying robust training method. In this instance, training can be defined with respect to various abstract transformations of inputs into a network. Formally, the transformation robust training problem under consideration can be defined as follows: let N:Rⁿ→R^{m} be a neural network with parameters θ, L be a loss function, and Xₜᵣₐᵢₙ be a training set of two-tuples on the form (x, y) where x∈Rⁿ and y is a training annotation. Moreover, let T:Rⁿ→Rⁿ be a transformation parameterized by a∈R^{k} and let A⊂R^{k}. The transformation robust training problem can further be defined as follows:

$${min}_{θ} {E}_{( x , y ) ∈ {𝒳}_{train}} [ {max}_{a ∈ A} L ( N ( T ( x ; a ) ) ; y ) ] . \qquad ( 3 )$$

Note that robust training methods may not inherently support the transformation T. However, for a given input x, the transformation may be encoded by prepending the neural network with transformation layers, which take as input the parameters a. The transformation layers can be specific to T and the inputs x, and may encode the exact transformation or an approximation of the transformation. However, the resulting transform network can be supported by the robust training method. The transform network can be denoted as N_{T}x.

The robust training problem may now be reduced to robust training of the network N_{T}x against perturbations of its input a as specified by an input set A. Thus, any robust training method that supports N_{T}x with the input set A may now be applied to the robust training problem.

A minimal instantiation of a robust training method with transformation layers is presented in the method 500. As in the methods 100 and 200, the method 500 takes as input 502, a network N, loss function L, and a stop condition StopCondition. Different from the methods 100 and 200, the method 500 does not take as input the set Xₚₑᵣₜ, but instead takes as input the training data (Xₜᵣₐᵢₙ) and the input set A.

Similar to the methods 100 and 200, the method 500 can execute through nested loops, until a stop condition is met/satisfied (lines 1 and 2, 504-506). For each input x (line 2, 506), the computer system used, such as those described herein, can create a transform network N_{T}x (line 3, 508). The transform network can be generated by augmenting the network. The network can be augmented with at least one transformation later. Specifics of the at least one transformation layer and its parameters can be based on the input dataset. Next, the computer system can use a relaxation of the network using the input set A, annotation y, and the loss function, to calculate an upper bound (denoted L⁻ rob) on the robust loss function (denoted L_{rob}) (line 4, 510). The annotation y can indicate a desired output for the corresponding input x. In at least some instances, the computer system can additionally, or alternatively, calculate a lower bound on the robust loss function. Finally, the network parameters can be optimized by the computer system, via standard neural network training methods, e.g., stochastic gradient descent (line 5, 512).

The robust training presented in the method 500 can be combined with other training approaches for neural networks, which includes, but may not be limited to, regularization techniques such as f₁- and f₂-loss, artificial data augmentation such as flips and rotations, various loss functions, and/or various optimization methods such as stochastic gradient descent-based methods and/or evolutionary methods.

The method 500 can be used to train the model with different types of perturbations, not just white noise. For example, if the computer system encodes the transformation T into an NN itself using standard NN layers and changes the input set A, the computer system can receive, as output, an image with a brightness transformation. The computer system can then perform robust training with respect to white noise of parameters for the set A. The method 500 can provide for robust training of existing transformations T of the dataset X for a wide range of permutations within the bounds for the input set A. For brightness, for example, the computer system can train the model to be robust with brightness transformations approximately in the range of about −5 to about +5. Those values can be considered the upper and lower bounds. The computer system can encode the brightness transformation into each NN layer (or a subset of the layers). The brightness can be considered additive noise. The computer system can add light metrics as one row to the dataset, then multiple each by input A. As a result, the computer system is able to take an original image in the dataset that was an input and add to a bias field of a corresponding layer to add the input A to the original image, which can be considered the brightness perturbations of the input image. The same or similar techniques can be performed to add contrast as a transformation to the input images of the dataset.

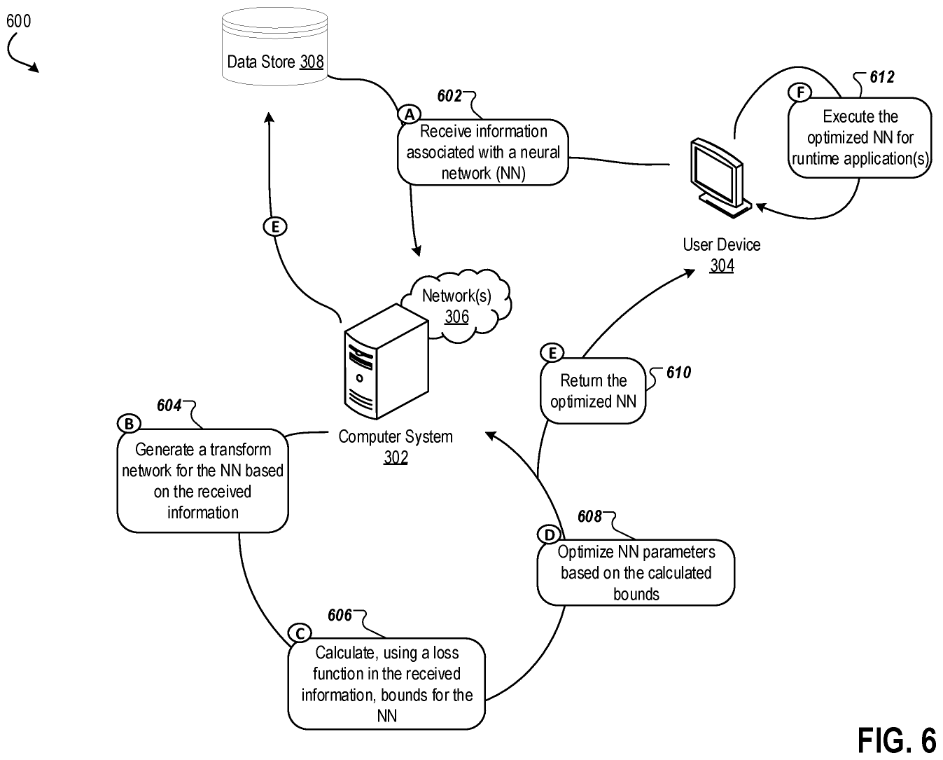

FIG. 6 is a conceptual diagram of a system 600 for training an NN with transformation layers. The system 600 can include the computer system 302, the user device 304, the data store 308, and the network(s) 306 described in reference to FIG. 3.

In the system 600, the computer system 302 can receive information associated with an NN in block A (602). The information can include but is not limited to the NN, a loss function for the NN, and/or a training dataset. The information can be received from the user device 304 and/or the data store 308.

The computer system 302 can generate a transform network for the NN based on the received information in block B (604). For example, the computer system 302 can generate the transform network based on augmenting the NN. More specifically, the computer stem 302 can generate the transform network based on augmenting the training dataset.

Using the loss function for the NN, the computer system 302 can calculate bounds for the NN in block C (606). The computer system 302 can calculate upper and/or lower bounds on a robust function for the NN. In at least some instances, calculating the bounds for the NN can include applying one or more relaxation techniques to the transform network. The relaxation techniques can include, but are not limited to, RSIP, SSIP, and/or abstract interpretation-based methods. The relaxation techniques may additionally, or alternatively, include SIP, semidefinite program (SDP) based methods, partial linearization of an ReLU activation function, and/or total linearization of the ReLU activation function.

In block D, the computer system 302 can then optimize one or more parameters of the NN based on the calculated bounds (608). The parameter(s) can be optimized using one or more network training techniques described above. The example training techniques can include, but are not limited to, gradient descent, including stochastic variants such as ADAM, particle swarm optimization, and/or evolutionary optimization algorithms.

The computer system 302 can return the optimized NN in block E (612) to the user device 304 and/or the data store 308, as described in reference to at least FIG. 3. The user device 304 may, for example, execute the optimized NN for runtime application(s) (block F, 612).

As described in reference to FIG. 3, the blocks B-D (604-608) may be performed continuously and/or iteratively until some predetermined stop condition is satisfied.

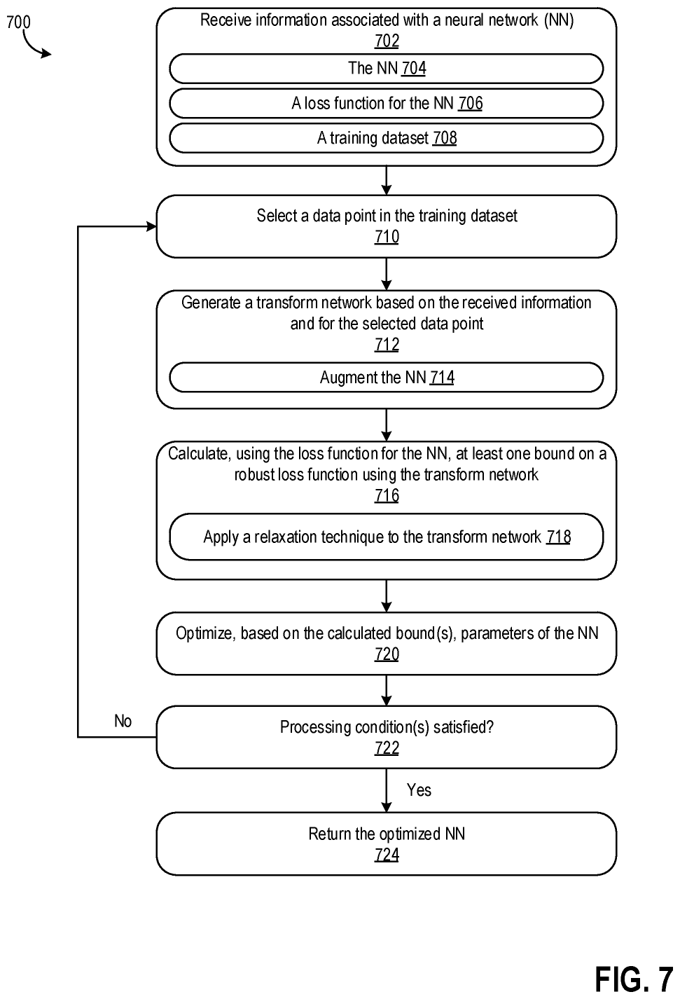

FIG. 7 is a flowchart of a process 700 for training an NN with transformation layers. The process 700 corresponds to operations described in reference to FIG. 6. The process 700 can be performed by the computer system 302. One or more blocks in the process 700 can also be performed by other computing systems, network of computing devices, and/or cloud-based computing systems. For illustrative purposes, the process 700 is described from the perspective of a computer system.

Referring to the process 700 in FIG. 7, the computer system can receive information associated with an NN in block 702. The information may include the NN (block 704), a loss function for the NN (block 706), and/or a training dataset (block 708).

The computer system can select a data point in the training dataset in block 710.

Then, the computer system can generate a transform network based on the received information and for the selected data point in block 712. For example, the computer system can augment the training dataset in block 714.

In block 716, the computer system can calculate, using the loss function for the NN, at least one bound on a robust loss function using the transform network. The bound can be an upper bound. Additionally, or alternatively, the bound can be a lower bound. The computer system may apply one or more relaxation techniques to the transform network to perform the calculation (block 718).

The computer system may optimize one or more parameters of the NN based on the calculated bound(s) in block 720.

In block 722, the computer system can determine whether one or more processing conditions is/are satisfied. If the processing condition(s) is not satisfied, the computer system returns to block 710 and repeats through one or more of the blocks 712-720 until the processing condition(s) is satisfied. If the processing condition(s) is satisfied, the computer system proceeds to block 724, in which the computer system returns the optimized NN.

RSIP-SSIP with Transformation Layers

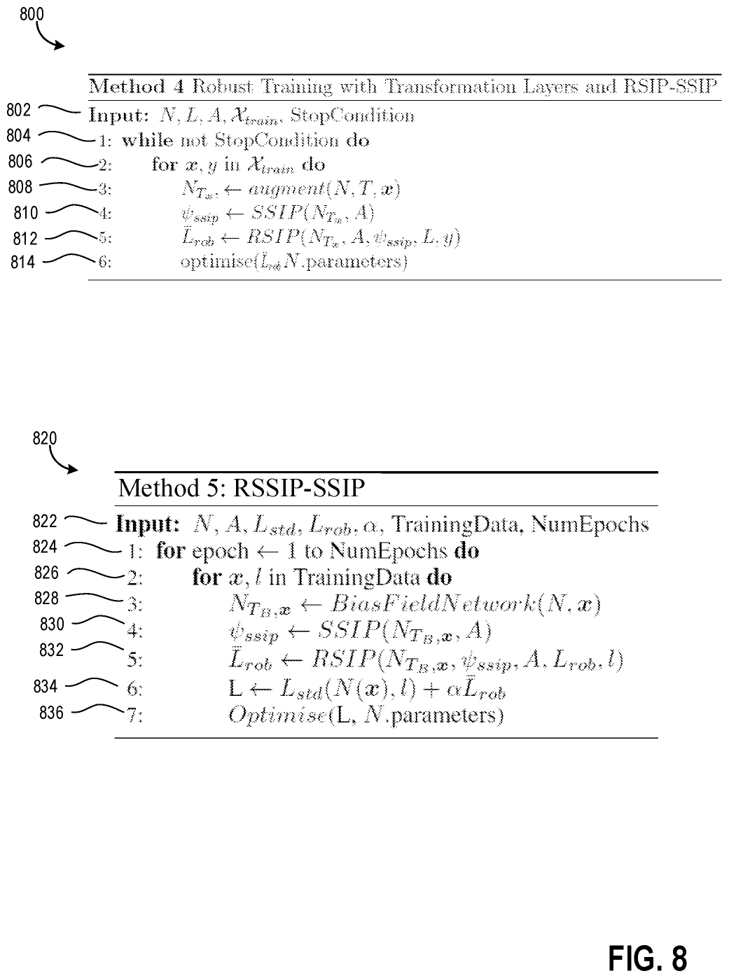

FIG. 8 illustrates example methods 800 and 820 for robust training of an NN with transformation layers and using RSIP-SSIP training techniques. Existing techniques, such as RSIP-IBP can provide robust training in which an upper bound relaxation of an inner maximization for the NN is calculated using IBP and RSIP techniques. The combination of IBP and RSIP techniques may reduce computational cost for RSIP but also bounds produced by IBP can be beneficial for robust training against 1_{∞}-perturbations. However, since RSIP-IBP only supports 1_{∞}-perturbations of the input variables, and not bias field transformations, RSIP-IBP cannot be applied directly to calculate relaxations used for bias field perturbations. The foregoing notwithstanding, RSIP-IBP can be applied to bias field transformations using the disclosed techniques for transform networks. Accordingly, RSIP-IBP may not be optimal for bias field robust training due to looseness of resulting bounds. This section describes RSIP-SSIP techniques that can address one or more of the shortcomings of RSIP-IBP, especially for more computationally efficient, low-dimensional input networks, such as bias field networks. To create a relaxation for an inner maximization, this section defines bias field robust training and techniques for defining a bias field robust training problem as an optimization problem with respect to 1, perturbations of one or more coefficients.

As described herein, the methods 800 and 820, and other RSIP-SSIP techniques described herein or otherwise derivable in view of the present disclosures, can be implemented with bias field perturbations to improve robustness of NN training. Bias field transformations can be considered additive and multiplicative spatially varying polynomials. Bias fields and bias field transformations may be defined as the following: regarding bias fields, let A k-th order bias field B^{k}(a)∈Rⁿ parametrized by a is defined as B(a)=Σₜ₌₀^{k} aₜb^{t} for aₜ∈R and b^{t}∈Rⁿ where bᵢ^{t}=(i/n)^{t}.

Regarding bias field transformations, a k-th order bias field transformation T^{k}:Rⁿ→Rⁿ can be defined as T_{B}^{k} (x; a^{m}, a^{a})=x⊙B^{m}(a^{m})+B^{a}(a^{a}) where B^{m} and B^{a} are k-th order multiplicative and additive bias fields. Here “⊙” can denote a Hadamard product. Each individual bias field can be a linear combination of polynomial vectors, which can be used to determine different noise. This definition for bias field transformations may assume inputs in Rⁿ for ease of presentation. However, extension to R^{n×m} can be straightforward by considering bias fields on the form:

$$B = {\sum }_{t = 0}^{k} {\sum }_{g = 0}^{k} {a}_{i , g} {b}^{i , g} for {a}_{i , g} ∈ ℝ and$$

$${b}^{t , o} ∈ {ℝ}^{n \times m} where {b}_{i , j}^{t , g} = {( i / n )}^{t} {( j / m )}^{g} .$$

Robustness to bias field perturbations can be defined with respect to 1_{∞} perturbations of the bias field's coefficients a^{a}, a^{m}, which can be formalized as follows: regarding bias field robustness, let N:Rⁿ→R^{m} be a neural network, x∈Rⁿ be a input, T_{B} be a bias field transform, and A^{m}={a^{m}|a^{m}_{i,low}≤a^{m}≤a^{m}_{i,up}, a^{m}_{i,low}, a^{m}_{i,up}∈R} and A^{a}={a^{a}|a^{a}_{i,low}≤a^{a}≤a^{a}_{i,up}, a^{a}_{i,low}, a^{a}_{i,up}∈R} be sets of parameters for the bias field transform. The network N can be bias field robust for x, A^{m}, and A^{a} if N (T_{B}(a^{m}, a^{a}; x)) satisfies ψ_{y} for all a^{a}∈A^{a} and a^{m}∈A^{m}.

Building on the definition for bias field robustness, bias field robust training, the bias field transform network, and a reduced bias field robust training problem can be defined as follows: let N:Rⁿ→R^{m} be a neural network with parameters θ, Xₜᵣₐᵢₙ be a training distribution, L be a loss function, and T_{B} be a bias field transform. Moreover, let A^{m}={a^{-m}:∥a^{-m}−a^{m}∥_{∞}<λ} and A^{a}={a^{-a}:∥a^{-a}−a^{a}∥_{∞}<λ} with a^{m}, a^{a}∈R^{k}, λ∈R, be sets of parameters for the multiplicative and additive bias fields in the bias field transformation. The bias field robust training problem can be defined as the following example optimization problem:

$${min}_{θ} {E}_{( x , y ) ∈ {𝒳}_{train}} [ {max}_{{a}^{m} , {a}^{a} ∈ {A}^{m} , {A}^{a}} L ( N ( {T}_{B} ( {a}^{m} , {a}^{a} ; x ) ) ; y ) ] . \qquad ( 4 )$$

In some implementations, A^{m} and A^{a} can be limited by which types of perturbations may be supported by SIP. For example, this can include white noise/box-constraints, where a_{i, low}<=a_i′<=a_{i, up}, which can represent a superset of the infinity-norm described above. Sometimes, it can also be defined by 1-norm. One or more other definitions for A^{m} and A^{a} may also be possible.

Regarding the bias field transform network, let N:Rⁿ→R^{m} be a neural network and let T_{B} be the k-th order bias field transform defined by the bias fields B^{m}(a^{m})=Σₜ₌₀^{k}aᵢ^{m}b^{m,2} and B^{a}(a)=Σₗ₌₀^{k}aₗⁿb^{a,1}. For a given input x, the bias field transform network N_{TB},X:R^{2k}→R^{m} is given by N_{TB},X(a^{m}, a^{m})=N(W_{TB},x[a^{m}, a^{a}]), where W_{TB},x=[x⊙b^{m,0} . . . , x⊙b^{m,k}, b^{a,0}, . . . , b^{a,k}] and [a^{m}, a^{a}] can be the concatenation of a^{m} and a^{m}.

Regarding reduced bias field robust training, let N:Rⁿ→R^{m} be a neural network with parameters θ, X be a training distribution, and T_{B} be a k-th order bias field transform. Moreover, for each x in the training distribution let N_{TB},x be the bias field transform network corresponding to x, N and T_{B}, and let A^{m}={a^{-m}:∥a^{-m}−a^{m}∥_{∞}<λ} and A^{a}={a^{-a}:∥a^{-a}−a^{a}∥_{∞}<λ} with a^{m}, a^{a}, ∈R^{k}, λ∈R. The reduced bias field optimization problem can be defined as:

$${min}_{θ} {E}_{( x , y ) ∈ 𝒳} [ {max}_{{a}^{m} , {a}^{a} ∈ {A}^{m} , {A}^{a}} L ( {N}_{{T}_{B} , x} ( {a}^{m} , {a}^{a} ) ; y ) ] . \qquad ( 5 )$$

The network N_{TB},x(a^{m}, a^{a}) can be the neural network N, with a prepended fully connected layer with weight matrix W_{TB},x that encodes the bias field transform TB for a given x and takes the bias field transform coefficients a^{m}, a^{a} as input. Because the transform layers are fully connected layers, and RSIP-SSIP techniques described herein, or otherwise derivable from the present disclosures, can support fully connected layers, N_{TB},x can be supported whenever N is supported. Moreover, because N_{TB},x=N(T_{B}(a^{m}, a^{a}; x)), the solution to the optimization problem as defined by the reduced bias field robust training shown above can be the same as in the definition for bias field robust training.

Still referring to FIG. 8, the method 800 provides an instantiation of the methods 200 and 500. The methods 800 and 820 can extend the method 100 to RSIP-SSIP techniques described herein, in which transformations can be encoded into an NN. The methods 800 and 820 provide an efficient way to produce robust metrics for the NN. The method 800, for example, enables robust training of transformations where a set of parameters for the transformation A is induced by box constraints, such as A={a|a_{i,low}≤a≤a_{i,up}, a_{i,low}, a_{i,up}∈R}.

Similar to the method 500, the method 800 takes as input 802 network N, loss function L, training data Xₜᵣₐᵢₙ, transformation parameter set A, and a stop condition StopCondition. The method 800 can iterate through loops, as shown by lines 1 and 2 (804-806). For each input x, the method 800 can create a transform network N_{T}x (line 3, 808). For example, the computer system can augment each input data in the dataset using the transformation parameters set A.

Next, the computer system can implement SSIP techniques described herein to calculate bounds for all intermediate nodes (or a portion of the intermediate nodes) in the network (denoted ψₛₛᵢₚ) (line 4, 810). The intermediate bounds from SSIP can then be used in RSIP techniques described herein to calculate an upper bound (denoted L⁻ rob) and/or a lower bound on a robust loss function (denoted L_{rob}) (line 5, 812). Finally, network parameters can be optimized by the computer system in line 6 (814) via standard neural network training methods, including but not limited to stochastic gradient descent.

The robust training method presented in the method 800 may be combined with typical training approaches for neural networks, which may include, but is/are not limited to, regularization techniques such as f₁- and f₂-loss, artificial data augmentation such as flips and rotations, various loss functions, and/or various optimization methods such as stochastic gradient descent-based methods and/or evolutionary methods.

In the method 820, the computer system takes as input 822 the network N, a set of parameters for bias field perturbation A, standard loss function L_{std}, a robustness loss L_{rob}, a weighting parameter α, training data, and a number of training epochs. L_{rob} may be the loss function L_{std} under a worse case perturbation. Sometimes, L_{rob} can be adapted to facilitate bound calculation. In some implementations, L_{std} and L_{rob} can be user defined. A weight factor can be applied between the two loss functions. In some implementations, L_{rob} in the method 820 can be the same as or similar to the loss function L described in reference to the methods 100, 200, 500, and/or 800. Sometimes, same or similar results can be achieved using the methods 800 and 820 by setting the L_{std} equal to 0 and the weight factor equal to 1. As described herein, the L_{std} can be introduced into the method 820 to add more flexibility by combining a standard training loss with another robust loss function.

For each epoch of the number of training epochs (line 1, 824), an inner training loop can be performed for each data point in the training dataset (line 2, 826). In the inner training loop, the computer system can first initialize a bias field transform network N_{T}B,x (line 3, 828). Next, SSIP bounds can be calculated for all layers in the network, or a portion of the layers in the network (ψₛₛᵢₚ) (line 4, 830), followed by calculating RSIP upper bound(s) for the robustness loss (L⁻ rob) (line 5, 832). The RSIP techniques may use the bounds from the SSIP calculation, such that back-propagating the gradients through the RSIP upper bound also back-propagates the gradients through the SSIP bounds.

The standard training loss may also be calculated with respect to the output of a forward pass and total loss can be a weighted sum of the robust loss and standard loss (line 6, 834). One or more parameters of the network can be optimized with respect to this loss via back-propagation (line 7, 836). In the method 820, unlike the methods 100, 200, 500, and 800, the loss function is split into two parts: standard loss and robust loss. This can provide additional flexibility at least because the robust loss does not have to exactly mimic the standard loss.

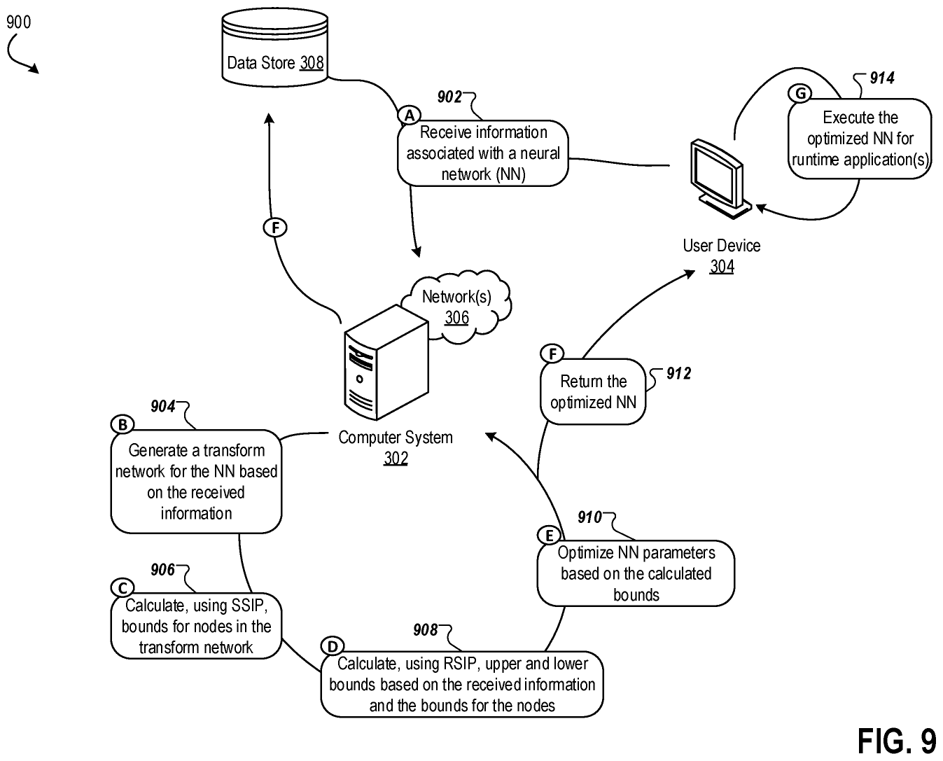

FIG. 9 is a conceptual diagram of a system 900 for training an NN with transformation layers using RSIP-SSIP training techniques described above in reference to at least FIG. 8. Even applying some noise to network inputs can affect performance of the NN. Most NNs, however, are not robust in this sense. Some methods can train NNs to be robust against white noise (e.g., snow in videos and/or images can appear as black and white/salt and pepper noise), but may not extend beyond to other perturbations. Perturbations in the form of contrast can be defined as: x′=ax for a \in R (where R can denote a set of real numbers). Perturbations in the form of brightness can be defined as: x′=x+a for a \in R. Perturbations in the form of bias field can also be used, as described and defined above. Perturbations in the form of white noise can be defined as: X={x|xi,low≤x≤xi,up, xi,low, xi,up∈R}. Perturbations in the form of hue changes can be defined such that a hue value for all or some pixels in an image can vary within some predefined bounds. Perturbations may additionally, or alternatively, be in the form of geometric changes to images or other inputs (e.g., zoom, rotation, translation). In some implementations, contrast and/or brightness perturbations may be subsumed by bias field perturbations.

The perturbations can be defined in one or more other ways. For example, any type of perturbation can be encoded into one or more layers of the NN and/or a composition of multiple layers of the NN (e.g., transform layers, so long as the SSIP and RSIP techniques described herein can support the transform layers). The perturbations can be encoded into a variety of layers, including but not limited to one or more of the following types of layers: Fully Connected, Convolution, Transposed Convolution, Pooling, Batch Normalization, Reshape, Crop, Slice, Concatenation, Division, Multiplication, Addition, Subtraction, Flatten, Unsqueeze, Transpose, and/or Global Average Pooling. One or more additional layers may also be added, if needed and/or desired, thereby allowing the disclosed techniques to support various perturbation types based on pre-pending transform layers that may encode a desired perturbation.

The techniques described herein, such as shown by the system 900 in FIG. 9, can introduce bias field perturbations to train NNs instead of just white noise. Bias field perturbations are smooth and traditionally have been used to measure noise in MRI imaging. The disclosed technology introduces new ways to encode noise patterns of bias field perturbations into NNs to enhance training and robustness of the NNs.

Similar to the system 300, the system 900 may include the computer system 302, the user device 304, the data store 308, and/or the network(s) 306.

The computer system 302 can receive information associated with an NN to be trained in block A (902). The information can be received and/or retrieved from the data store 308 and/or the user device 304. The information can include, but is not limited to, the NN, a loss function for the NN, and/or a training dataset for the NN. In some implementations, the computer system 302 can also receive various hyperparameters, such as regularization methods (e.g., 11, 12, weight decay) and/or data augmentation schemes (e.g., randomly rotate all images by a maximum of X degrees). The loss function can be user defined, in at least some implementations. Sometimes, default loss functions can be implemented for specific problem domains (e.g., mean squared error (MSE) for regression and/or cross-entropy loss for classification). Some loss functions may dynamically modify their respective parameters during training (e.g., the loss function may increase a weight of robust versus standard loss as training progresses). Sometimes, loss functions may be automatically determined with one or more search approaches, such as a machine learning-based search.

The computer system 302 can generate a transform network for the NN based on the received information in block B (904). The transform network, as defined above, can include a concatenation of one or more transform layers and a standard NN. For example, for at least one data point in the training dataset, the computer system 302 can generate the transform network by augmenting the NN. In other words, the computer system 302 can add a transform layer to a start point of the NN. For example, for a brightness transform and an image input x, a transform layer can be created that takes as input a real variable c \in R and outputs c+x. By pre-pending this layer to the NN, the original network can operate on the transformed image c+x. In some implementations, the computer system 302 can generate the transform network for all data points in the training dataset.

In block C (906), the computer system 302 can calculate bounds for nodes in the transform network, using, for example, SSIP techniques. The bounds can be linear equations l(x) and u(x) corresponding to a value at some point, or node, in the underlying NN. The bounds can satisfy l(x)<=f(x)<=u(x) for all inputs x that satisfy one or more box constraints provided to the SIP techniques. Here f(x) can be a value attained in the NN. The vector x can represent the network's input. The computer system 302 can calculate the bounds for at least a portion of the nodes in the transform network, including one or more intermediate nodes in the transform network. Sometimes, the computer system 302 can calculate the bounds for all the intermediate nodes in the transform network. Intermediate nodes may include nodes that are between an input node and an output node of the transform network. In some implementations, the intermediate nodes can include any value computed in the NN (at least because the SSIP techniques can be used to calculate bounds for all the values).

The computer system 302 can also calculate upper and/or lower bounds, using, for example, RSIP techniques, with the calculation being based on the received information and/or the bounds for the nodes (block D, 908). The upper and/or lower bounds can be calculated on a robust loss function for the NN. The robust loss function can be, for example, an upper bound for the maximum loss function for any input x in the training dataset. The robust loss function can be calculated, for example, with RSIP-SSIP techniques, as described further below. The upper and/or lower bounds can be determined, for example, based on the calculated bounds for at least a portion of the intermediate nodes. Additionally, or alternatively, the upper and/or lower bounds can be determined based on the loss function for the NN. Still further, additionally, or alternatively, the upper and/or lower bounds can be determined based on the transform network. It shall be understood that, throughout this disclosure, the terms upper and lower bounds can be used interchangeably with the term bounds. Moreover, it shall be understood that the terms upper and lower bounds or bounds can be used interchangeably for the intermediate nodes of the NN. In some implementations, either upper or lower bounds may be of interest, and designated as such. For example, sometimes only an upper bound is of interest for the loss function.

Next, the computer system 302 can optimize one or more parameters of the NN based on the calculated bounds in block E (910) to minimize the loss. The parameters can be optimized using known NN training techniques. The parameter(s) can be optimized based on the upper and/or lower bounds. Additionally, or alternatively, the parameter(s) can be optimized based on the bounds for the intermediate nodes. The parameters may include weight and/or bias parameters of layers of the NN. Optimization techniques can be performed via standard optimizers, including but not limited to ADAM, root means square propagation (RMSProp), and/or other stochastic gradient descent-based methods. Other methods, such as evolutionary algorithms, may also be applied to optimize the parameters.

In some implementations, blocks B-E (904-910) can be continuously or iteratively performed until one or more conditions are satisfied/met to stop performing the blocks B-E (904-910). The conditions may include, but are not limited to, a predetermined number of iterations, the loss becomes smaller than some predetermined threshold value, and/or the loss decreases less than a predetermined threshold amount over a last predetermined number of the iterations. As an illustrative example, the blocks B-E (904-910) may be performed until the computer system 302 has run through all data points in the training dataset and performed the blocks B-E (904-910) for each of the data points in the training dataset. As yet another illustrative example, the computer system 302 can perform the blocks B-E (904-910) for a predetermined number of epochs (e.g., a few hundred epochs to a thousand epochs). One epoch, for example, can be complete when all data points in the training dataset have been processed once.

The computer system 302 can then return the optimized NN (block F, 912) to the user device 304 and/or the data store 308. The user device 304 can be configured to execute the optimized NN for runtime application(s) in block G (914). The data store 308 can be configured to store the optimized NN in association with a user of the user device 304 for later retrieval, training, and/or runtime application(s).

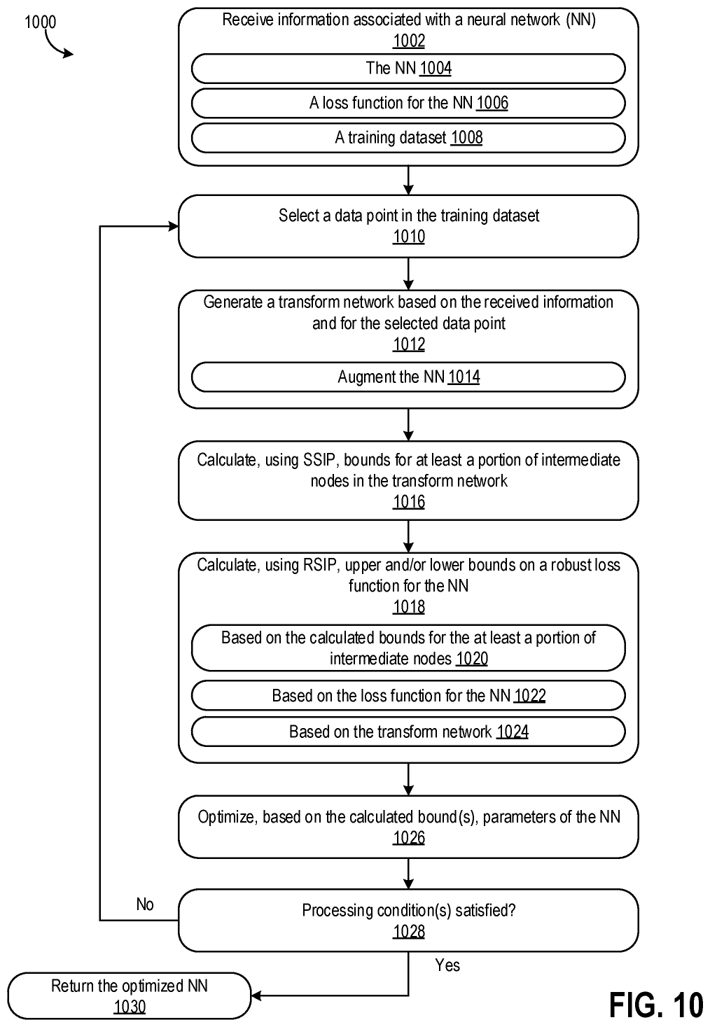

FIG. 10 is a flowchart of a process 1000 for training an NN with transformation layers using RSIP-SSIP training techniques described herein. Transformation layers can be any combination of standard NN layers for which a resulting operation encodes one or more perturbations under consideration. Sometimes, the transformation layers can be derived from a definition of the perturbation(s) under consideration for the NN. In some implementations, the transformation layers can be learned using standard NN training methods. The process 1000 corresponds to operations described in reference to FIG. 9. The process 1000 can be performed by the computer system 302. One or more blocks in the process 1000 can also be performed by other computing systems, network of computing devices, and/or cloud-based computing systems. For illustrative purposes, the process 1000 is described from the perspective of a computer system.

Referring to the process 1000 in FIG. 10, the computer system can receive information associated with an NN in block 1002. The information may include the NN (block 1004), a loss function for the NN (block 1006), and/or a training dataset (block 1008).

The computer system can select a data point in the training dataset in block 1010.

Then, the computer system can generate a transform network based on the received information and for the selected data point in block 1012. For example, the computer system can augment the network in block 1014. By way of further example, the computer system may generate the transform network by pre-pending a transform layer to the NN (or augmenting the NN with another layer). In some implementations, the training dataset may additionally, or alternatively, be augmented with one or more known NN training techniques, including but not limited to adding noise, rotating images, and/or flipping images in the training dataset.

In block 1016, the computer system can calculate, using, for example, SSIP techniques, bounds for at least a portion of intermediate nodes in the transform network.

The computer system can also calculate, using, for example, RSIP, upper and/or lower bounds on a robust loss function in block 1018. This calculation can be based on the calculated bounds for the at least a portion of intermediate nodes (block 1020), the loss function for the NN (block 1022), and/or the transform network (block 1024).

The computer system may also optimize one or more parameters of the NN based on the calculated bound(s) in block 1026.

In block 1028, the computer system can determine whether one or more processing conditions is/are satisfied. The conditions, as described herein, may include whether a predetermined number of iterations and/or training epochs have been met. The conditions may include the loss being below a predetermined threshold level. The conditions may include a last few iterations/epochs showing little or no improvement to the loss (e.g., a predetermined number of last iterations and/or epochs showing less than a predetermined amount of improvement to the loss). One or more other conditions can also be defined and used with the disclosed techniques.

If the processing condition(s) is not satisfied, the computer system returns to block 1010 and repeats through one or more of the blocks 1012-1026 until the processing condition(s) is satisfied. If the processing condition(s) is satisfied, the computer system proceeds to block 1030, in which the computer system returns the optimized NN.

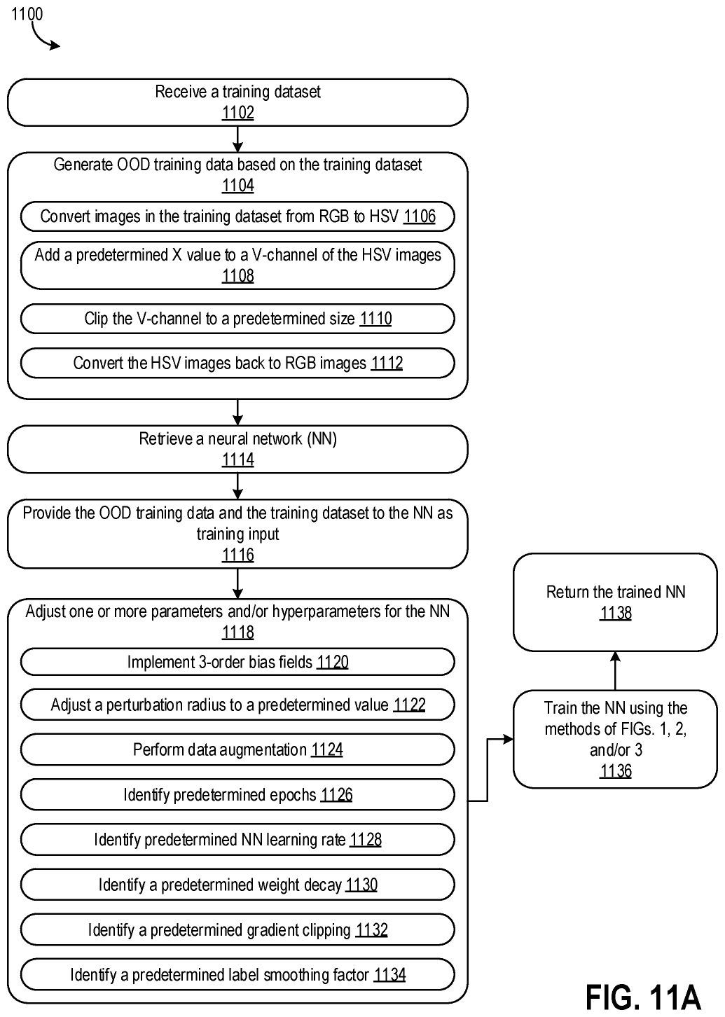

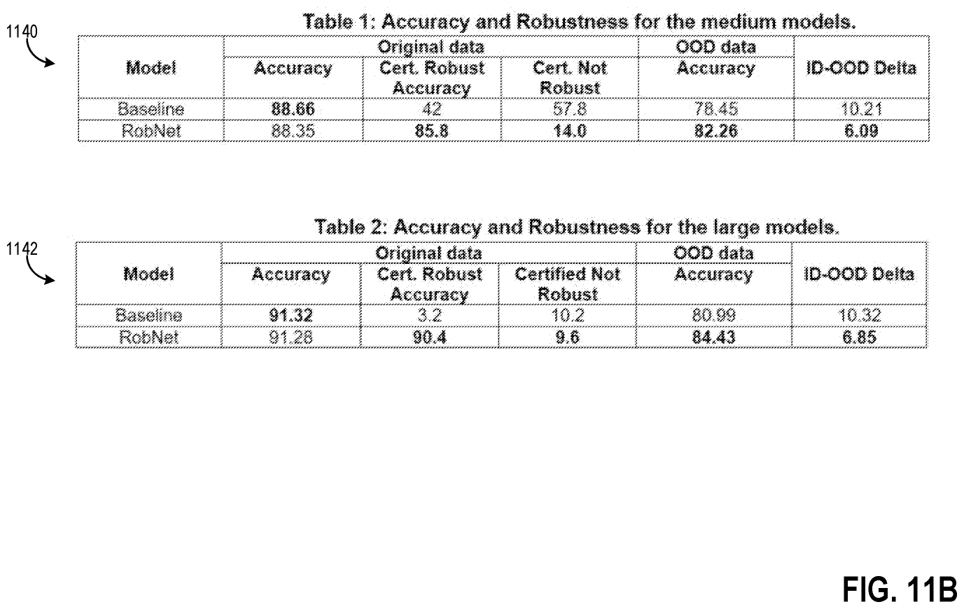

FIG. 11A is a flowchart of a process 1100 for training an NN with out-of-distribution (OOD) data using RSIP-SSIP training techniques. The process 1100 is similar to or the same as techniques described herein, such as in FIGS. 8, 9, and 10. The process 1100 can be performed by the computer system 302. One or more blocks in the process 1100 can also be performed by other computing systems, network of computing devices, and/or cloud-based computing systems. For illustrative purposes, the process 1100 is described from the perspective of a computer system.

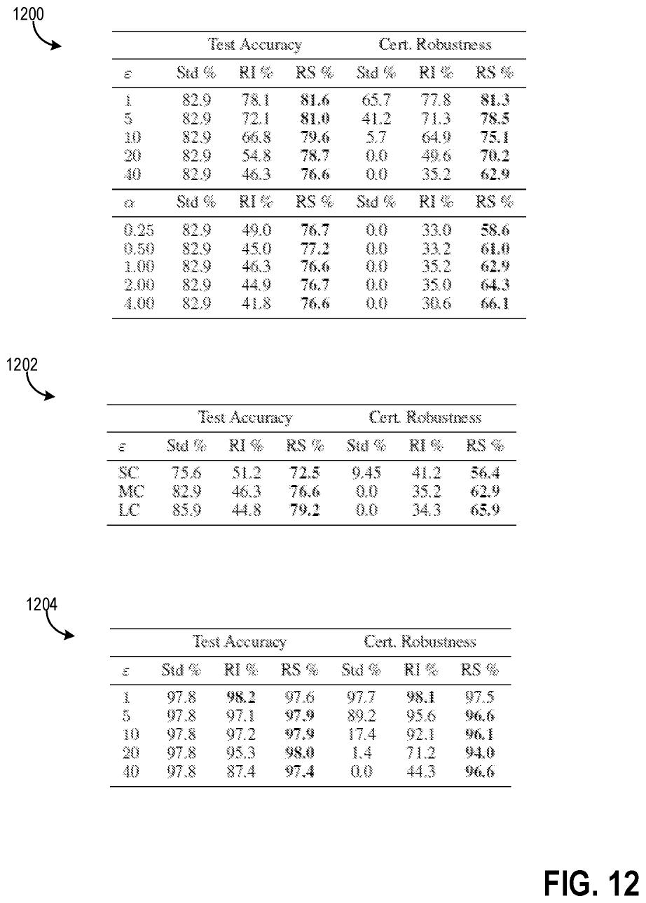

More specifically, the illustrative example of process 1100 can be performed for neural network-based image classifier training with the RSIP-SSIP training techniques. Results from this training, as shown at least in FIGS. 11B and 12, indicate that robustly trained networks using the disclosed techniques experience improved performance on OOD data than networks trained with other techniques.

Referring to the process 1100 in FIG. 11A, the computer system can receive a training dataset in block 1102. The training dataset, in an illustrative non-limiting example, can include an original CIFAR-10 training dataset.

The computer system can generate OOD training data based on the training dataset (block 1104). For testing, the original CIFAR-10 test dataset, as well as a version of the dataset modified to model OOD data, can be utilized. The OOD data can be intended to model images drawn from a brighter distribution than the original CIFAR-10 data. Specifically, the OOD data can be created by converting all images in the test set (or a portion of the images) from red, green, blue (RGB) to hue, saturation, value (HSV) (block 1106). The computer system can then add a predetermined X value to a V-channel of the HSV images in block 1108. For example, the computer system can add X=75/255 to the V-channel to model brightness increase. The computer system can also clip the V-channel to a predetermined size in block 1110. For example, the computer system can clip the V-channel to [0,1] to ensure that all pixel intensities take on valid values. The computer system can finally convert the HSV images back to RGB images in block 1112 to generate the OOD data.

The computer system can retrieve a neural network to be trained in block 1114. In some implementations, the block 1114 can be performed before, during, or after one or more other blocks in the process 1100. For example, block 1114 can be performed before, during, or after receiving the training dataset in block 1102.

Different types of model architectures can be used in the process 1100. For example, a medium size neural network can be used, with four (4) convolutional layers followed by two (2) fully connected layers and ReLU activation functions in each layer. This architecture, in one example, may have a total of 2,468,906 trainable parameters. Another type of model architecture can be a large size neural network with five (5) convolutional layers followed by one (1) fully connected layer and ReLU activation functions in each layer. This architecture can have a total of, in one example, 17,191,626 trainable parameters.

In block 1116, the computer system can provide the OOD training data and the training dataset to the NN as training input.

The computer system can then adjust one or more parameters and/or hyperparameters for the NN (block 1118). Any one or more of blocks 1120-1134 can be performed as part of adjusting the parameters and/or hyperparameters. Additional or other operations can be performed to adjust the parameters and/or hyperparameters. Sometimes, the blocks 1119-1134 can be performed as part of network training in block 1136.

As illustrative examples of adjusting the parameters and/or hyperparameters, the computer system can implement 3-order bias fields (e.g., 3-order additive bias fields) (block 1120). As described throughout this document, a bias field perturbation can be a spatially dependent value adjustment of an input value. For example, for input images, the bias field perturbation can include making some areas of the image darker to model shades. Lower order bias field perturbations can be smooth changes, while higher order bias field perturbations can provide more abrupt changes to the input value. For example, brightness perturbations can be implemented with 0-order bias field perturbations, which means there is a smooth change in every pixel such that every pixel (or a group of pixels) may be adjusted by a same amount. 3-order bias fields in the illustrative example of block 1120 can include a more abrupt change than the 0-order bias fields.

The computer system may adjust a perturbation radius to a predetermined value in block 1122. For example, the radius can be set to 0.05 for a pixel intensity range 0-1. A range for the radius can be unique and adapted to each use case/implementation. As an illustrative example, with images and intensity ranges of 0 to 1, the radius can be given a value within an approximate range of about 0.001 to about 2. The range for the radius can be greater or smaller depending on the particular use case/implementation.

The computer system can perform one or more data augmentation techniques in block 1124. For example, the computer system can perform horizontal flips on the training input with a probability of 0.5 and/or random cropping with a predetermined padding value (e.g., 4-pixel padding). One or more additional or other augmentations can be performed. As merely illustrative and non-limiting examples, geometric transformations can be performed, such as random flips, crops, rotations, and/or translations of the training input. Color space transformations can be made, such as changing RGB to HSV color channels, brightness, contrast, and/or other color transformations with random and/or predetermined intensity changes. The augmentations may include kernel filters, such as sharpening and/or blurring the training input with randomized and/or predetermined intensities. The augmentations may additionally, or alternatively, include random erasing, such as removing a part of an image/the training input. The augmentations may include mixing one or more images or training inputs, such as randomly mixing/combining multiple images in the training dataset. One or more other augmentation techniques that are practiced in NN training may also be implemented with the disclosed techniques.

The computer system can identify predetermined epochs for performing the disclosed techniques (block 1126). For example, the computer system can identify 100 epochs. One (1) epoch may be defined as running through a loop of training until all the training data has been processed once. The number of epochs can be set to a maximum within a computational budget. In some implementations, the loss can be monitored during training and training may sometimes be aborted if the loss has converged; in other words, the loss value may seem to remain almost constant over an extended period of time. One or more other techniques may be used to determine an appropriate number of epochs for performing the disclosed techniques.

Further, the computer system can identify a predetermined NN learning rate in block 1128. The learning rate can be, for example, 0.005. The learning rate and/or values for the learning rate may depend, at least in part, on a type of optimizer that is being used (such as a variant of gradient descent). Generally, a higher learning rate can indicate that the optimizer is configured to make larger changes to parameters of the NN in each iteration than a lower learning rate. The large learning rate may result in faster learning at the start of the process, but may sometimes be problematic for fine-tuning towards the end of the process. Learning rate schedulers may sometimes be used to modify (e.g., reduce) the learning rate after a predetermined number of epochs. Some optimizers, such as ADAM, may automatically adjust the learning rate during training. In some implementations, an initial learning rate can be highly dependent on the data type, network architecture, and/or the optimizer(s) being used. The initial learning rate can be discovered via trial and error, in some implementations. As a merely illustrative example, the initial learning rate value can be approximately in the range of about 0.00001 to about 1.0.

In at least some instances, the computer system can identify a predetermined weight decay in block 1130. For example, the computer system can determine a weight decay value of 0.0005. After each training iteration, all parameters (or a subset of the parameters) in the NN can be multiplied by (1-weight decay). As a result, only values approximately within a range of about 0 to about 1 can be used. As a merely illustrative example, values smaller than 0.01 may be used as the weight decay value. The weight decay value can be used with the disclosed techniques to reduce overfitting issues that may arise.

Additionally, or alternatively, the computer system can identify a predetermined gradient clipping value in block 1132. For example, the computer system can determine the gradient clipping value as 0.1. Gradient descent and related optimizers may use gradients (closely related to derivatives) to determine how to adjust each parameter in the NN. Parameters for which the gradient is large can be adjusted by a larger amount than parameters for which the gradient is small. Gradient clipping can be used to reduce all gradients with a magnitude larger than the provided value to the provided value. For example, with a gradient clipping value of 0.1, acceptable gradients can be within a range [−0.1, 0.1]. Gradients that are smaller than −0.1 can be set to −0.1 and gradients that are larger than 0.1 can be set to 0.1. Gradient clipping may be used to speed up training convergence and reduce overfitting issues that may arise.

Additionally, or alternatively, the computer system can identify a predetermined label smoothing factor in block 1134. The label smoothing factor can be, for example, 0.1. Label smoothing may be used with training classification networks. With label smoothing, a one-hot encoded vector of a correct class in a training dataset (denoted y) can be replaced by: Y′=(1−α)*y+α/K, where a can be α smoothing factor and K can be a number of classes. y can be a vector of length K where every element is 0, except the element corresponding to the correct class. y′ can be a vector where every element is in an example range of 0 to 1. For α>0, the element corresponding to the correct class can be larger than all other elements also in y′. Smoothing factors between 0 and 1 can be preferred, and typically the smoothing factor may be closer to 0 than 1. As an illustrative example, the smoothing factor can be a value within the range of 0.01 to 0.2

In block 1136, the computer system can train the NN using any of the training methods described herein. One or more training methods can be used in the illustrative example of the process 1100 to highlight accuracy in results from using the RSIP-SSIP techniques described herein. One or more additional or other training methods may also be used to test and show accuracy of the RSIP-SSIP techniques. As described herein, the training can stop after a predetermined number of epochs, which further can depend on a computing budget for the training. After training, the computer system can analyse how the loss behaved during later stages of the training. If the loss converged, the training can stop. If the loss still seems to vary significantly towards the end of training, it can be determined whether to continue training for another predetermined number of epochs. Similar training techniques for NNs can be used here.

Once training is complete, the computer system can return the trained NN in block 1138. As described in reference to at least FIG. 3, the trained NN can then be used in runtime applications by relevant users. In some implementations, returning the trained NN can include performing one or more iterative training techniques. For example, the training can first include training the NN without a robust loss, then the network can be trained with robust loss. Sometimes, a robust model can be trained, then training results can be saved. Multiple runs can then be started where the model can continue to be trained with various training configurations. Specifically, hyperparameter settings can be adjusted with the multiple runs of training, such as learning rate, weight decay, etc. Sometimes, the model can be trained after use in production, such as due to discovering new faults, requirements, and/or obtaining new training data.

FIG. 11B illustrates tables 1140 and 1142 showing results from training the NN with OOD data using RSIP-SSIP training techniques as described in the process shown in FIG. 11A. The table 1140 contains results for training medium size models with the disclosed techniques (also referred to as DM-Medium models). The table 1142 contains results for training large size models with the disclosed techniques (also referred to as DM-Large models). The illustrative results can be computed on 500 samples with a 10 second timeout. In these illustrative examples, “Cert. Robust Accuracy” can indicate a percentage of data points verified to be robust while “Certified Not Robust” can indicate a percentage of a counterexample.

The tables 1140 and 1142 show that similar results exist for both the medium and large sized models. The disclosed training techniques can have improved certified robustness on original data and accuracy on OOD data as compared to training models with other techniques. Therefore, models trained to be robust against perturbations using the disclosed techniques can perform better on OOD data than models that are not trained with robust training techniques, such as RSIP-IBP.

FIG. 12 illustrates tables 1200, 1202, and 1204 showing results from training NNs using RSIP-SSIP training techniques described herein. Bias field perturbations can model changes in lighting conditions for natural images and inhomogeneities, such as in MRI images. The tables 1200, 1202, and 1204 show illustrative results from testing the disclosed techniques in two (2) applications, an exemplary training dataset and an MRI brain tumor classification dataset, respectively. The training dataset can contain 10 classes of natural images and can be used in experimental evaluations of robust training methods. The MRI dataset can contain, for example, 7023 two-dimensional (2D) slices of brain scans where a task is to classify each scan as one (1) of four (4) tumor classes.

In the illustrative example of FIG. 12, networks can first be trained for 200 epochs without robust loss, of which 80 epochs can use a learning rate of 10⁻³, 80 used 10⁻⁴, and 40 used 10⁻⁵. After initial training, the networks can be trained for 100 epochs with a learning rate of 5×10⁻⁴, while a perturbation radius can be evenly increased from 0 to a radii under consideration. Finally, 50 epochs can be trained with a learning rate of 5×10⁻⁵, 25 epochs with 5×10⁻⁵, and 25 epochs with 5×10⁻⁶. These latter learning rates for robust training can consider both test accuracy and certified robustness of the networks. Typically there may be a trade-off between these metrics, i.e., one can be increased at the cost of reducing the other. Thus, both metrics can be taken into consideration when evaluating performance of the robust training techniques described herein or otherwise derivable from the present disclosures.

In the example of FIG. 12, robustness to third-order multiplicative bias field perturbations can be considered. A coefficient of the bias fields' constant term can be constrained to [1 ε; 1+ε] and remaining terms can be constrained to [−ε, =15; ε/15]. The certified robustness can be evaluated with RSIP-SSIP over all data points in the training dataset.

The table 1200 shows results for an example network trained with the training dataset, the network having a DM-Medium architecture (e.g., 7 layers, 62,000 ReLU nodes, and 2.5 million parameters) with various perturbation radii and loss-weights. The table 1200 contains results for standard (pre-robust training) networks (Std), RSIP-IBP networks (RI), and RSIP-SSIP networks (RS). For all ε (perturbation radii) and α (weight of the robust loss), the test accuracy and certified robustness for the RSIP-SSIP networks are shown to be better than the corresponding RSIP-IBP networks. For small &, the accuracy and robustness of networks trained with RSIP-IBP may be comparable to RSIP-SSIP; however, the RSIP-IBP results may deteriorate for larger ε. RSIP-SSIP also may achieve approximately 31% higher certified robustness than RSIP-IBP with ε=40 and their best α values (α=4 and α=1, respectively).

The table 1202 shows example results for DM-Small and DM-Large architecture models using the training dataset. DM-Small models can have, for example, four (4) layers, 6,000 ReLU nodes, and 215,000 parameters, while DM-Large models can have seven (7) layers, 230,000 ReLU nodes, and 17 million parameters. For all architectures in the illustrative example of FIG. 12, RSIP-SSIP can provide networks with significantly better accuracy and certified robustness than RSIP-IBP, and the difference may increase for larger networks.

The table 1204 shows illustrative results for a MRI brain tumor classification network (e.g., nine (9) layers, 311,000 ReLU nodes, and 17 million parameters). The network can receive, as input, MRI slices with one (1) channel and 128×128 pixels. In this illustrative example, for large perturbations, RSIP-SSIP outperforms RSIP-IBP both on accuracy and certified robustness. The large perturbations can be larger than or equal to ε=5, as an illustrative example.

The results in the tables 1200, 1202, and 1204 can show that for larger perturbation radii, RSIP-SSIP trained networks are more robust and accurate than RSIP-IBP-trained networks. In the illustrative examples of FIG. 12, the perturbation values can be larger than or equal to 5. ε in the tables 1200, 1202, and 1204 are relative to pixel values within a range [0, 255]. Other examples described throughout this disclosure can assume pixel values within a range [0, 1]. One or more other ranges are also possible.

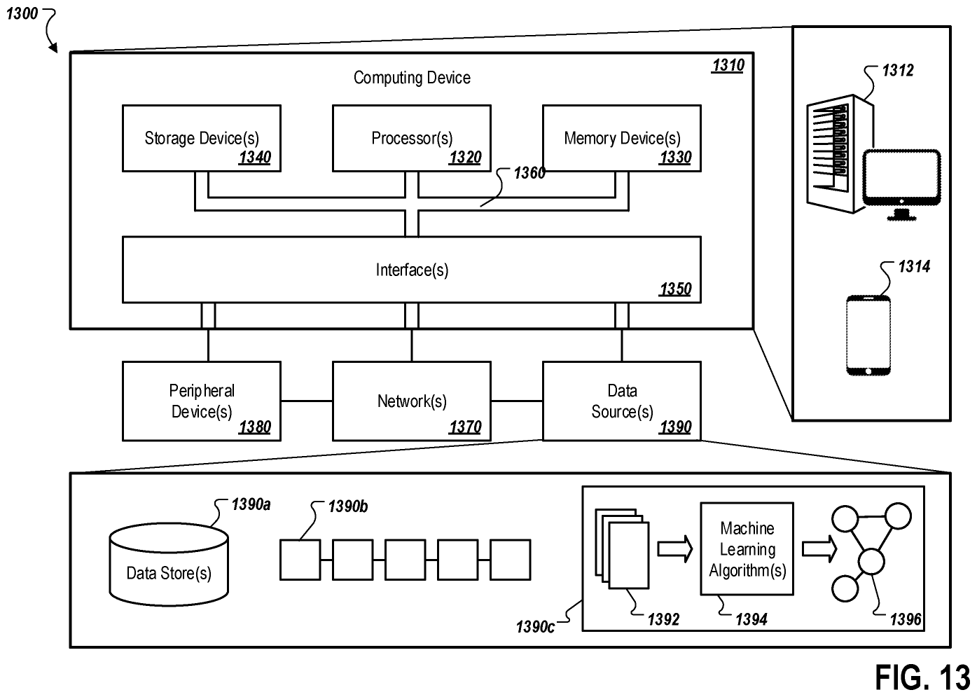

FIG. 13 is a schematic diagram that shows an example of a computing system 1300 that can be used to implement the techniques described herein. The computing system 1300 includes one or more computing devices (e.g., computing device 1310), which can be in wired and/or wireless communication with various peripheral device(s) 1380, data source(s) 1390, and/or other computing devices (e.g., over network(s) 1370). The computing device 1310 can represent various forms of stationary computers 1312 (e.g., workstations, kiosks, servers, mainframes, edge computing devices, quantum computers, etc.) and mobile computers 1314 (e.g., laptops, tablets, mobile phones, personal digital assistants, wearable devices, etc.). In some implementations, the computing device 1310 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 1310, and an entire system can be made up of multiple devices communicating with each other. For example, the computing device 1310 can be part of a computing system that includes a network of computing devices, such as a cloud-based computing system, a computing system in an internal network, or a computing system in another sort of shared network. Processors of the computing device (1310) and other computing devices of a computing system can be optimized for different types of operations, secure computing tasks, etc. The components shown herein, and their functions, are meant to be examples, and are not meant to limit implementations of the technology described and/or claimed in this document.

The computing device 1310 includes processor(s) 1320, memory device(s) 1330, storage device(s) 1340, and interface(s) 1350. Each of the processor(s) 1320, the memory device(s) 1330, the storage device(s) 1340, and the interface(s) 1350 are interconnected using a system bus 1360. The processor(s) 1320 are capable of processing instructions for execution within the computing device 1310, and can include one or more single-threaded and/or multi-threaded processors. The processor(s) 1320 are capable of processing instructions stored in the memory device(s) 1330 and/or on the storage device(s) 1340. The memory device(s) 1330 can store data within the computing device 1310, and can include one or more computer-readable media, volatile memory units, and/or non-volatile memory units. The storage device(s) 1340 can provide mass storage for the computing device 1310, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 1350 can include various communications interfaces (e.g., USB, Near-Field Communication (NFC), Bluetooth, WiFi, Ethernet, wireless Ethernet, etc.) that can be coupled to the network(s) 1370, peripheral device(s) 1380, and/or data source(s) 1390 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 1350 can include a control interface that receives commands from an input device (e.g., operated by a user) and converts the commands for submission to the processors 1320. The interface(s) 1350 can include a display interface that includes circuitry for driving a display to present visual information to a user. The interface(s) 1350 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 1370 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 1310 can communicate with the peripheral device(s) 1380, the data source(s) 1390, and/or other computing devices over the network(s) 1370. In some implementations, the computing device 1310 can directly communicate with the peripheral device(s) 1380, the data source(s), and/or other computing devices.

The peripheral device(s) 1380 can provide input/output operations for the computing device 1310. Input devices (e.g., keyboards, pointing devices, touchscreens, microphones, cameras, scanners, sensors, etc.) can provide input to the computing device 1310 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 1310 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 1390 can provide data for use by the computing device 1310, and/or can maintain data that has been generated by the computing device 1310 and/or other devices (e.g., data collected from sensor devices, data aggregated from various different data repositories, etc.). In some implementations, one or more data sources can be hosted by the computing device 1310 (e.g., using the storage device(s) 1340). In some implementations, one or more data sources can be hosted by a different computing device. Data can be provided by the data source(s) 1390 in response to a request for data from the computing device 1310 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 1390a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 1390b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 1390c. The machine learning system(s) 1390c, for example, can be used to analyze data from various sources (e.g., data provided by the computing device 1310, data from the data store(s) 1390a, data from the blockchain(s) 1390b, and/or data from other data sources), to identify patterns in the data, and to draw inferences from the data patterns. In general, training data 1392 can be provided to one or more machine learning algorithms 1394, and the machine learning algorithm(s) can generate a machine learning model 1396. Execution of the machine learning algorithm(s) can be performed by the computing device 1310, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation(s) of a subcombination. Similarly, while operations may be described in a particular order, this should not be understood as requiring that such operations be performed in the particular order or in sequential order, or that all operations be performed, to achieve desirable results, unless otherwise indicated or understood by a person skilled in the art. Particular embodiments of the subject matter have been described. Other embodiments are within the scope of the following claims.

What is claimed is:

1. A method for white noise robust training of a neural network (NN), the method comprising:
receiving, by a computer system, an NN, a loss function for the NN, and a dataset of perturbations;
iteratively, by the computer system:
calculating, using standard symbolic interval propagation (SSIP), bounds for at least a portion of intermediate nodes in the NN, wherein the calculating action using SSIP is based on the dataset of perturbations;
calculating, using reversed symbolic interval propagation (RSIP), at least one of an upper bound or a lower bound on a robust loss function, wherein the calculating action using RSIP is based on each of:
(i) the calculated bounds for the at least a portion of intermediate nodes;
(ii) the dataset of perturbations; and
(iii) the loss function for the NN;
optimizing, based on the calculated bounds and the at least one of an upper bound or lower bound, parameters of the NN; and
returning, by the computer system, the optimized NN.

2. The method of claim 1, wherein the neural network training techniques comprise stochastic gradient descent.

3. The method of claim 1, wherein optimizing the parameters of the NN uses NN training techniques.

4. The method of claim 1, wherein the loss function for the NN comprises a user-defined loss function value.

5. The method of claim 1, wherein the dataset of perturbations comprises at least one of bias field input changes, white noise input changes, brightness input changes, or contrast input changes.

6. The method of claim 1, wherein the dataset of perturbations comprises at least one perturbation that is encoded into: (i) one or more layers of the NN; or (ii) a composition of multiple layers of the NN.

7. The method of claim 1, wherein the parameters of the NN comprise at least one of weights or biases of layers of the NN.

8. The method of claim 1, further comprising:
receiving, by the computer system, a normal dataset; and
generating, by the computer system, the dataset of perturbations based on applying one or more rules to each data point in the normal dataset, the one or more rules specifying at least one of perturbations or neighborhoods of each data point.

9. A method for robust training of neural networks (NN) with a transform network, the method comprising:
receiving, by a computer system, an NN, a loss function for the NN, and a training dataset;
iteratively, by the computer system, and for at least one data point in the training dataset:
generating a transform network based on augmenting the NN;
calculating, using the loss function of the NN, at least an upper bound on a robust loss function for the NN, wherein the calculating action is based on applying a relaxation technique to the transform network; and
optimizing, based on the calculated upper bound, parameters of the NN; and
returning, by the computer system, the optimized NN.

10. The method of claim 9, wherein the iteratively generating, calculating, and optimizing operations are performed, by the computer system, until a predefined condition is satisfied.

11. The method of claim 9, wherein generating the transform network based on augmenting the NN comprises encoding one or more brightness transformations into at least one layer of the NN.

12. The method of claim 9, wherein generating the transformation network based on augmenting the NN comprises encoding one or more contrast transformations into at least one layer of the NN.

13. The method of claim 9,
wherein generating the transform network comprises pre-pending one or more transform layers to the NN,
wherein the one or more transform layers encode perturbations for which to robustify the NN against, and
wherein the transform network is a composition of the NN and the one or more pre-pended transform layers.

14. The method of claim 9, wherein the relaxation technique comprises at least one of RSIP, SSIP, SIP, abstract interpretation-based methods, software-defined perimeter (SDP) based methods, partial linearization of a Rectified Linear Units (ReLU) activation function, or total linearization of the ReLU activation function.

15. A method for training a neural network with transformation layers using reversed symbolic interval propagation (RSIP) techniques and standard symbolic interval propagation (SSIP) techniques (RSIP-SSIP techniques), the method comprising:
receiving, by a computer system, an NN, a loss function for the NN, and a training dataset;
iteratively, by the computer system, and for at least one data point in the training dataset:
generating a transform network based on augmenting the NN;
calculating, using SSIP, bounds for at least a portion of intermediate nodes in the transform network, wherein the calculating action using SSIP is based on the transform network;
calculating, using RSIP, at least one of an upper bound or a lower bound on a robust loss function, wherein the calculating action using RSIP is based on each of:
(i) the calculated bounds for the at least a portion of intermediate nodes;
(ii) the loss function for the NN; and
(iii) the transform network; and
optimizing, based on the calculated bounds and the at least one of an upper bound or lower bound, parameters of the NN; and
returning, by the computer system, the optimized NN.

16. The method of claim 15, wherein the iteratively generating, calculating, calculating, and optimizing operations are performed, by the computer system, until a predefined condition is satisfied.

17. The method of claim 15, wherein calculating, using RSIP, at least one of an upper bound or a lower bound on a robust loss function comprises back-propagating gradients through the at least one of an upper bound or a lower bound.

18. The method of claim 16, wherein calculating, using RSIP, at least one of an upper bound or a lower bound on a robust loss function further comprises back-propagating gradients through the calculated bounds for the at least a portion of intermediate nodes.

19. The method of claim 15, further comprising:
calculating a standard training loss function based on output of a forward pass of the NN;
calculating a total training loss function based on a weighted summation of the standard training loss function and the robust loss function; and
optimizing the parameters of the NN based on back-propagation using the total training loss function.

20. The method of claim 15,
wherein augmenting the NN comprises pre-pending one or more transform layers to the NN, and
wherein each of the one or more transform layers is based on the training dataset and at least one perturbation type.
